(19) United States
(12) Patent Application Publication
(10) Pub. No.: US 2020/0082385 A1
(43) Pub. Date: Mar. 12, 2020

(54) SYSTEM AND METHOD FOR MANAGING RESOURCE CONSUMPTION FOR ELECTRONIC TRANSACTION DATA PROCESSES

(71) Applicant: ROYAL BANK OF CANADA, Montreal (CA)

(72) Inventors: Stephen Allen EVANS, Toronto (CA); Vincent Wing Chiu LIU, Toronto (CA); Derek Kenton SZETO, Toronto (CA); Anthony Wai Hou Chan, Whitby (CA)

(21) Appl. No.: 16/563,792

(22) Filed: Sep. 6, 2019

Related U.S. Application Data
(60) Provisional application No. 62/727,921, filed on Sep. 6, 2018.

(51) Int. Cl. G06Q 20/36; G06F 9/50

(52) U.S. Cl. CPC G06Q 20/363; G06F 2209/5011; G06Q 20/3674; G06F 9/5011

(57) ABSTRACT

A method for executing a data processing task for an electronic transaction includes receiving an electronic transaction data set including parameters identifying a quantity of an electronic resource consumed from a purchaser resource pool by the data processing task;

upon receiving response signals indicative of instructions to defer execution of at least a portion of the data processing task thereby deferring a corresponding consumption of at least a portion of the quantity of the electronic resource from the purchaser resource pool, generating a second data processing task for releasing at least the portion of the electronic resource to the purchaser resource pool; and
generating deferred child data processing tasks for executing at least the portion of the data processing task at one or more future times which when executed, consume at least the portion of the quantity of the electronic resource from the purchaser resource pool.

### CROSS-REFERENCE TO RELATED APPLICATIONS

This application claims all benefit including priority to U.S. Provisional Patent Application 62/727,921, filed Sep. 6, 2018, and entitled SYSTEM AND METHOD FOR ELECTRONIC INSTALLMENT PAYMENT PLATFORM. The entirety of this application including appendices is hereby incorporation by reference.

### FIELD

The embodiments described herein relate to aspects of systems and methods for an electronic transaction platform, and in particular, some embodiments relate to systems and methods for managing resources for electronic transaction data processes.

### BACKGROUND

Data processing tasks for electronic transactions can consume large quantities of resources. Opportunities for controlling the consumption of these resources are often limited or are outside the control of a purchaser.

### SUMMARY

In some embodiments, one or more aspects of the present disclosure provide systems and methods for managing resource consumption or electronic transaction data processes. In some embodiments, the systems and methods provide mechanisms for deferring some resource consumption to a later time and/or to generate recurring data processing tasks which consume resources over a period of time.

In accordance with one aspect, there is provided a method for executing a data processing task for an electronic transaction. The method includes: receiving an electronic transaction data set including parameters associated with a first data processing task for executing the electronic transaction, the parameters identifying quantity of an electronic resource consumed from a purchaser resource pool by the data processing task; generating signals for communicating an electronic message to a destination associated with the purchaser resource pool, the electronic message communicating an option for deferring execution of at least a portion of the data processing task thereby deferring a corresponding consumption of at least a portion of the quantity of the electronic resource from the purchaser resource pool; upon receiving response signals indicative of instructions to defer execution, generating a second data processing task for releasing at least the portion of the electronic resource to the purchaser resource pool; and generating one or more deferred child data processing tasks for executing at least the portion of the data processing task at one or more future times; when executed, the one or more deferred child data processing tasks consuming at least the portion of the quantity of the electronic resource from the purchaser resource pool.

In accordance with another aspect, there is provided a method for executing a data processing task for an electronic transaction. The method includes: receiving an electronic transaction data set including parameters associated with a first data processing task for executing the electronic transaction, the parameters identifying quantity of an electronic resource consumed from a purchaser resource pool by the data processing task; upon determining from the parameters associated with the first data processing task for executing the electronic transaction satisfy a subscription condition, generating signals for communicating a subscription electronic message to the destination associated with the purchaser resource pool, the subscription electronic message communicating an option for triggering execution of a plurality of future data processing tasks for periodically consuming subscription quantities of the electronic resource from the purchaser resource pool; upon receiving subscription response signals indicative of a confirmation the option for triggering execution of a plurality of future data processing tasks for periodically consuming the subscription quantities, generating signals for initiating execution of the plurality of future child data processing tasks at one or more future subscription times.

In accordance with another aspect, there is provided a system for managing resource consumption for electronic transaction data processes. The system includes at least one processor configured for: receiving an electronic transaction data set including parameters associated with a first data processing task for executing the electronic transaction, the parameters identifying quantity of an electronic resource consumed from a purchaser resource pool by the data processing task; generating signals for communicating an electronic message to a destination associated with the purchaser resource pool, the electronic message communicating an option for deferring execution of at least a portion of the data processing task thereby deferring a corresponding consumption of at least a portion of the quantity of the electronic resource from the purchaser resource pool; upon receiving response signals indicative of instructions to defer execution, generating a second data processing task for releasing at least the portion of the electronic resource to the purchaser resource pool; and generating one or more deferred child data processing tasks for executing at least the portion of the data processing task at one or more future times; when executed, the one or more deferred child data processing tasks consuming at least the portion of the quantity of the electronic resource from the purchaser resource pool.

In accordance with another aspect, there is provided a non-transitory computer readable medium or media having stored thereon computer readable instructions which when executed by at least one processor, configure the at least one processor for: receiving an electronic transaction data set including parameters associated with a first data processing task for executing the electronic transaction, the parameters identifying quantity of an electronic resource consumed from a purchaser resource pool by the data processing task; generating signals for communicating an electronic message to a destination associated with the purchaser resource pool, the electronic message communicating an option for deferring execution of at least a portion of the data processing task thereby deferring a corresponding consumption of at least a portion of the quantity of the electronic resource from the purchaser resource pool; upon receiving response signals indicative of instructions to defer execution, generating a second data processing task for releasing at least the portion of the electronic resource to the purchaser resource pool; and generating one or more deferred child data processing tasks for executing at least the portion of the data processing task at one or more future times; when executed, the one or more deferred child data processing tasks consuming at least the portion of the quantity of the electronic resource from the purchaser resource pool.

In accordance with an aspect, there is provided a computer-implemented method for processing transactions. The method may include: receiving a set of transaction data associated with an original transaction, the transaction data including an electronic token; analyzing the set of transaction data to determine a credit card profile associated with the electronic token; analyzing the set of transaction data to identify when the original transaction is a subscription transaction or a spread transaction with a merchant; sending an electronic notification to a user associated with the credit card profile with information regarding the subscription transaction or the spread transaction; and upon receiving a confirmation from the user representative of an agreement to the subscription transaction or the spread transaction, processing the set of transaction data to generate new transaction data either as a one time data transaction or recurring set of transactions based on the subscription transaction or the spread transaction

In another aspect, the original transaction is the spread transaction, and the new transaction data comprises data required to generate a refund for the user and data required to generate a subsequent payment authorization equivalent to an amount of the refund.

In yet another aspect, the original transaction is the subscription transaction, and the new transaction data comprises data required to generate one or more subsequent payment authorizations based on the subscription transaction.

In still another aspect, the set of transaction data includes at least one of: credit card digits, credit card owner, Card Verification Value (CVV), merchant name, merchant ID, merchant location, merchant category, transaction ID, SKU, transaction amount, transaction currency, a bank identification number (BIN) and an Authorization Code.

In one aspect, the method may include receiving a set of user registration data comprising information regarding the credit card profile and registering the credit card profile based on the user registration data.

In another aspect, the method may include receiving a set of merchant registration data comprising information regarding the merchant. This may include MID (Merchant Identification Account), Location Identifier (specifies a merchant at a specific physical location, Visa Merchant Identification Account (VMID), and/or the like.

In still another aspect, the merchant registration data comprises at least one of: merchant name, merchant ID, merchant location, merchant contact details, merchant category, an offer, authorization codes, and payment details.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

FIG. 1A shows aspects of an example transaction processing system, in accordance with one embodiment.

FIG. 1B shows aspects of an example transaction processing system, in accordance with one embodiment.

FIG. 10 is a flowchart showing aspects of an example method for processing electronic transactions.

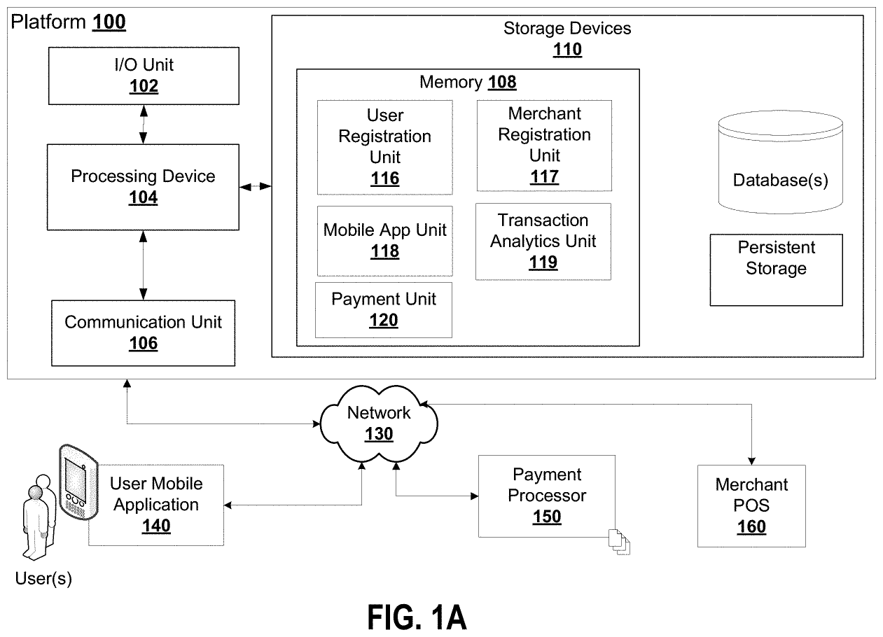

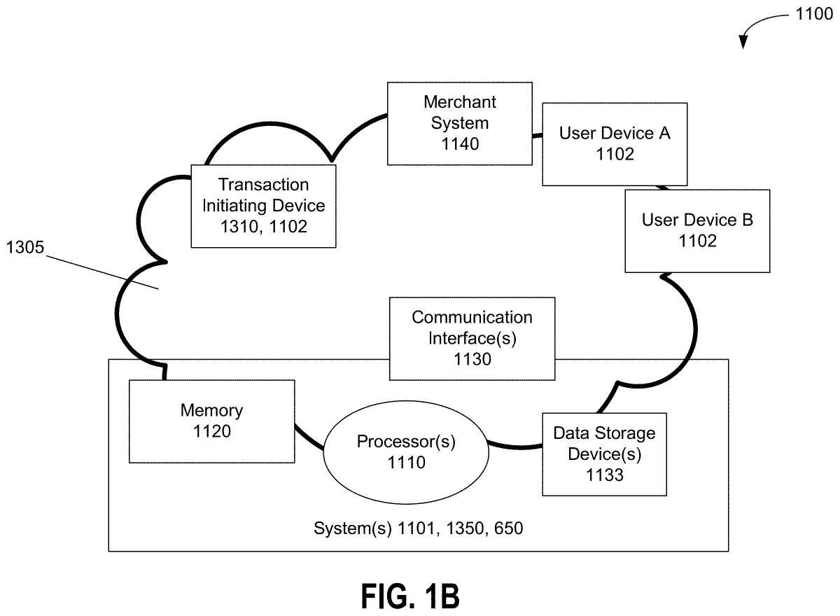

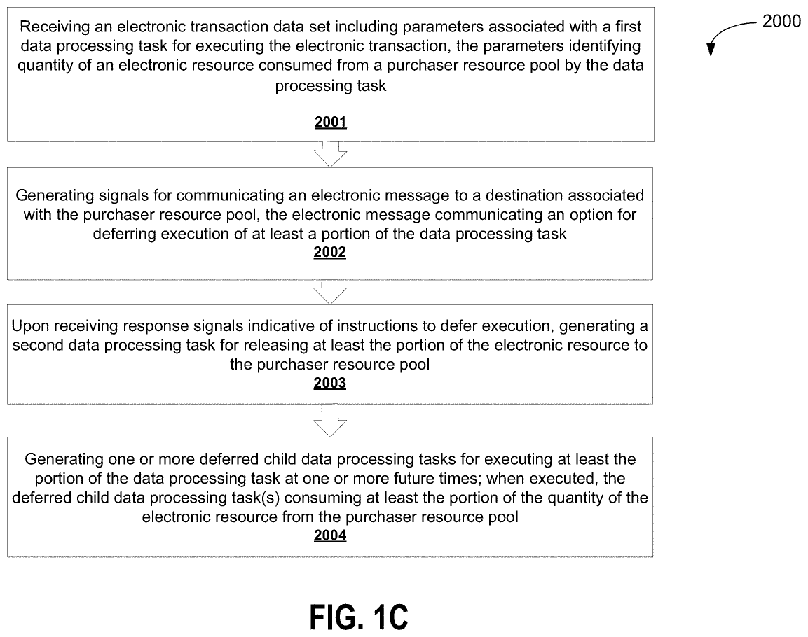

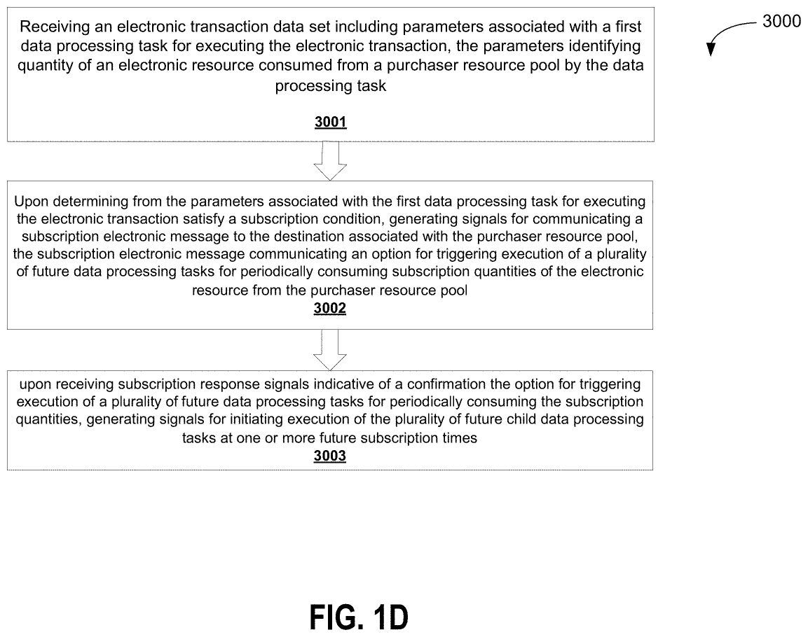

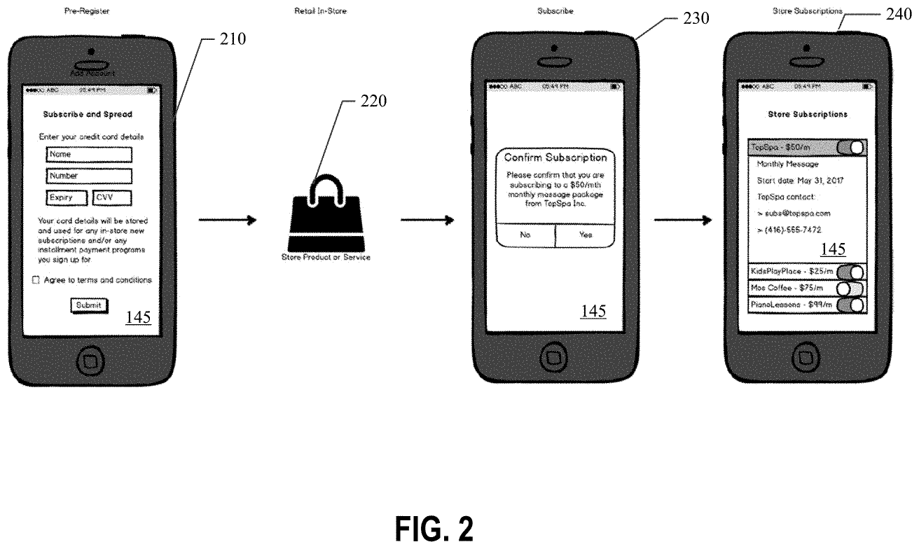

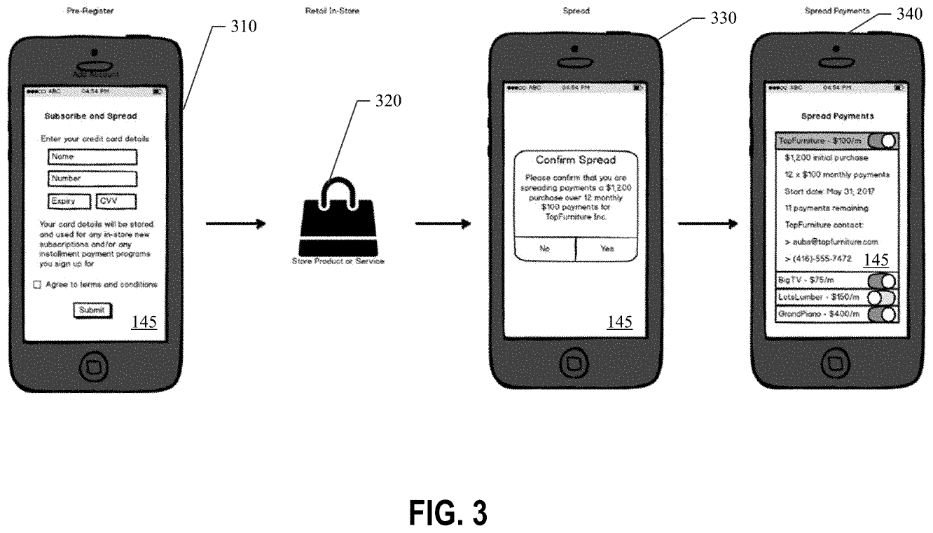

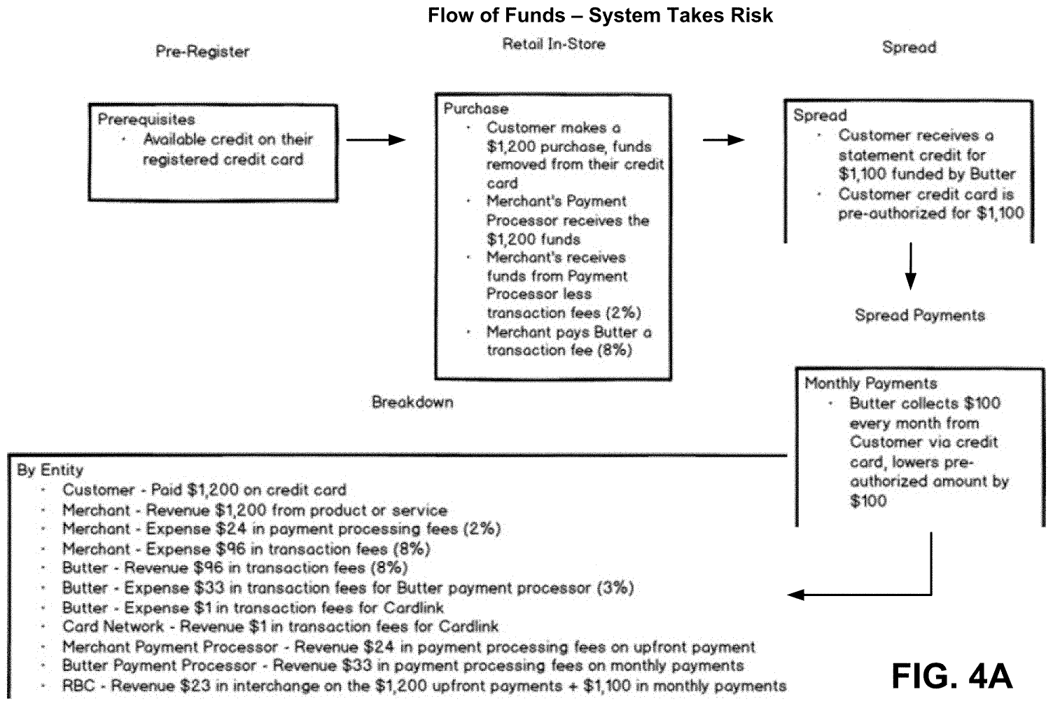

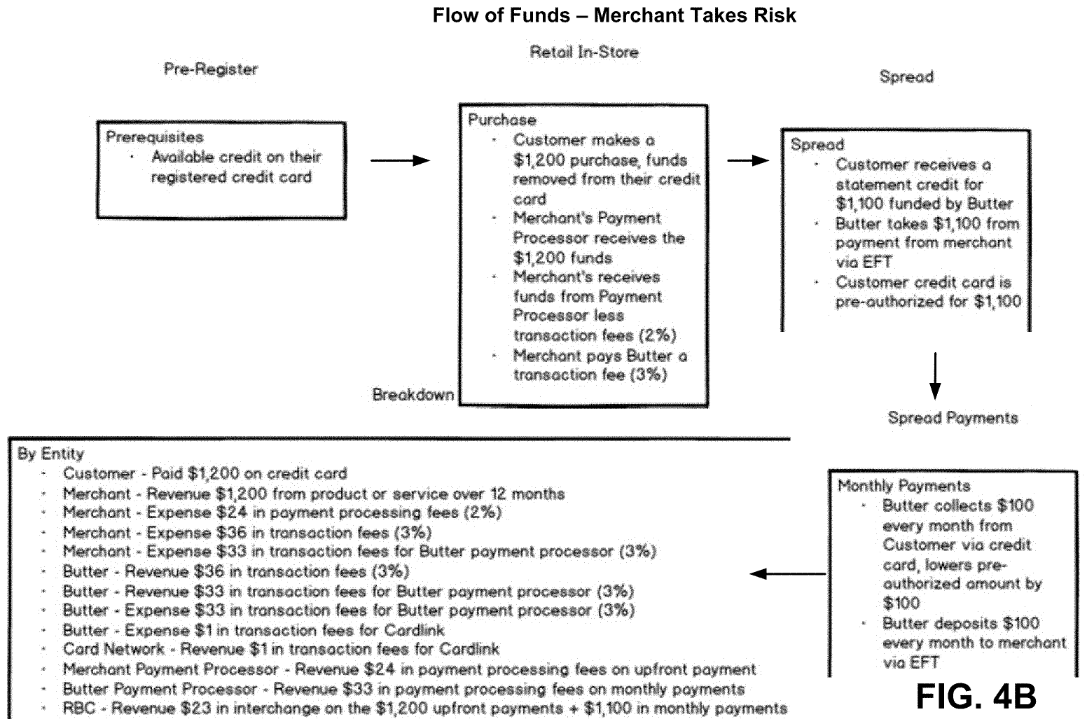

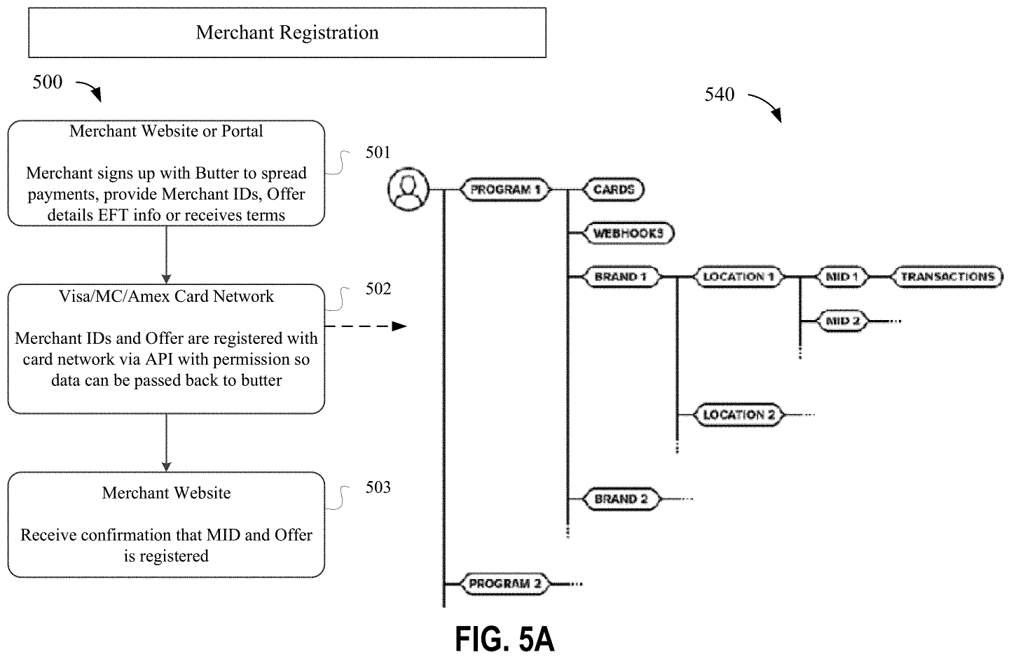

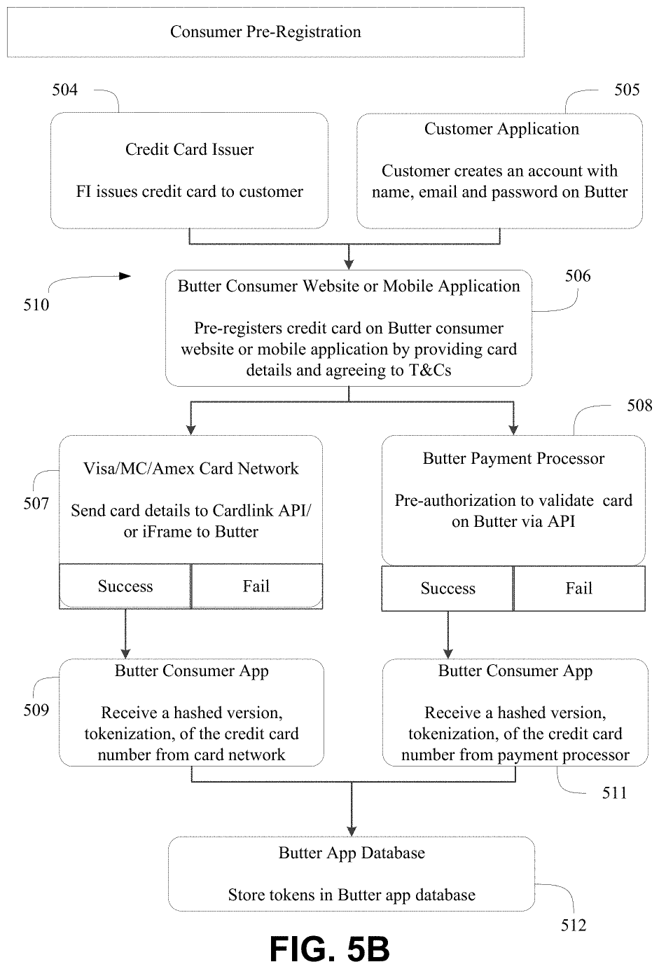

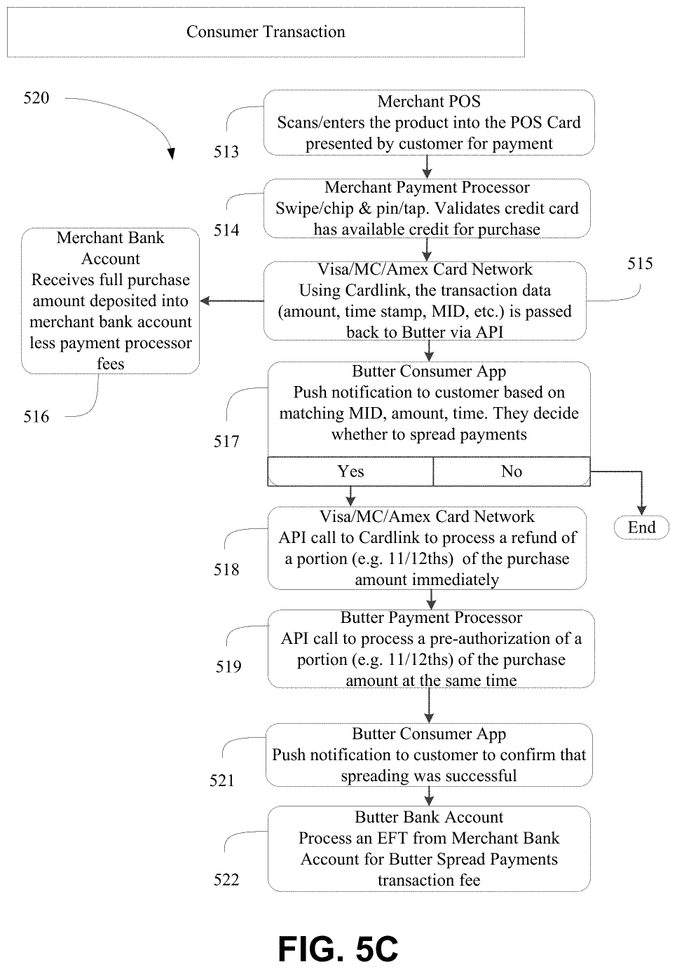

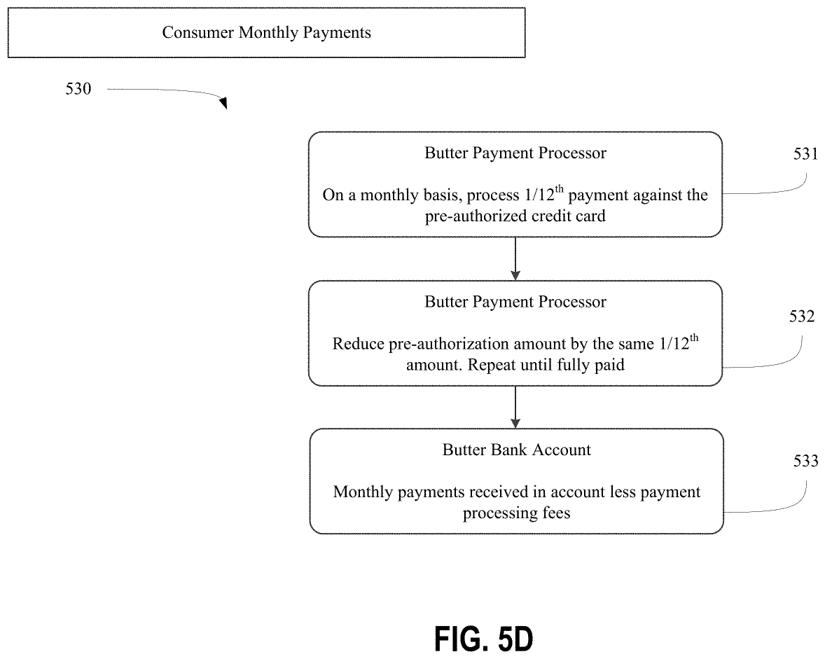

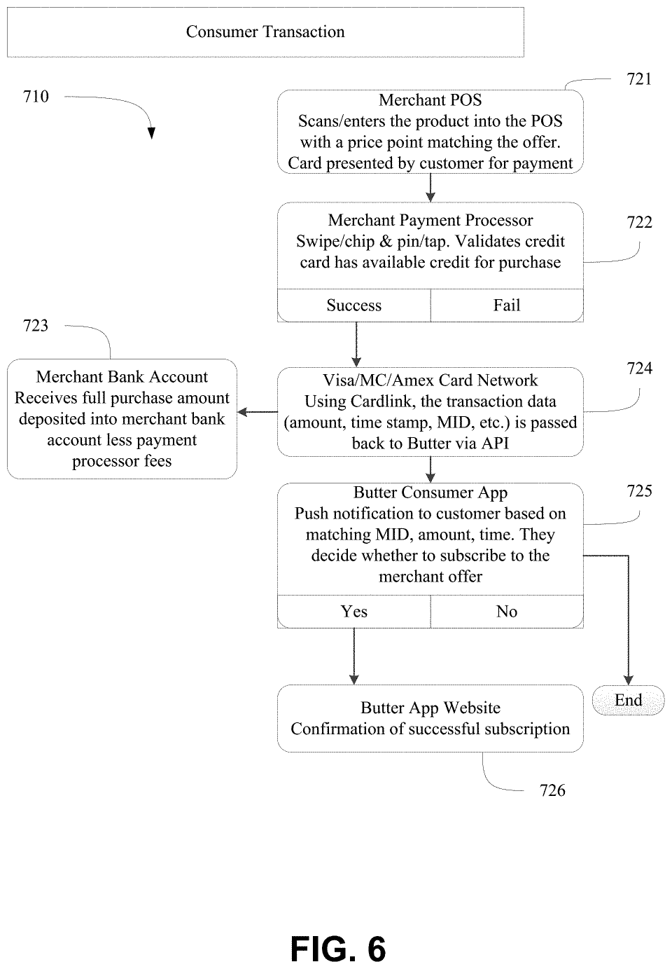

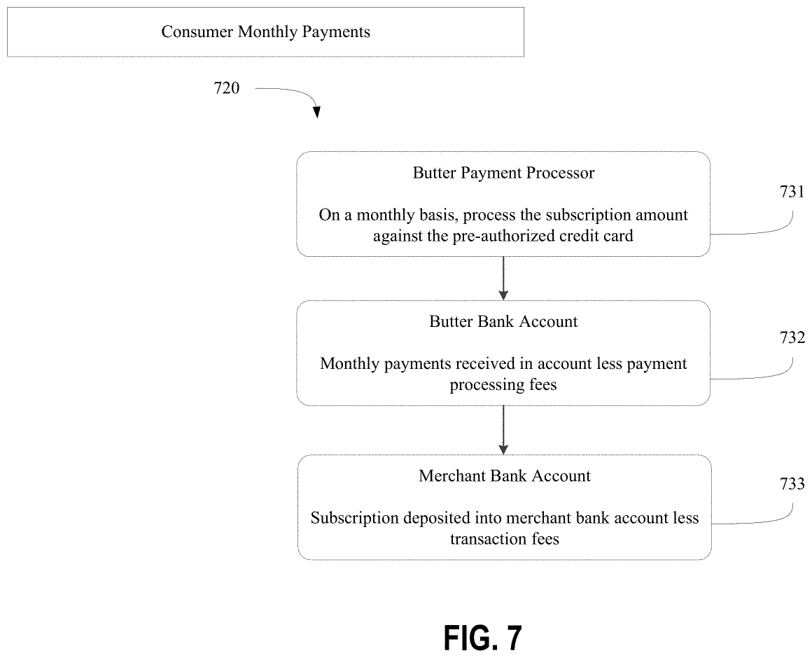

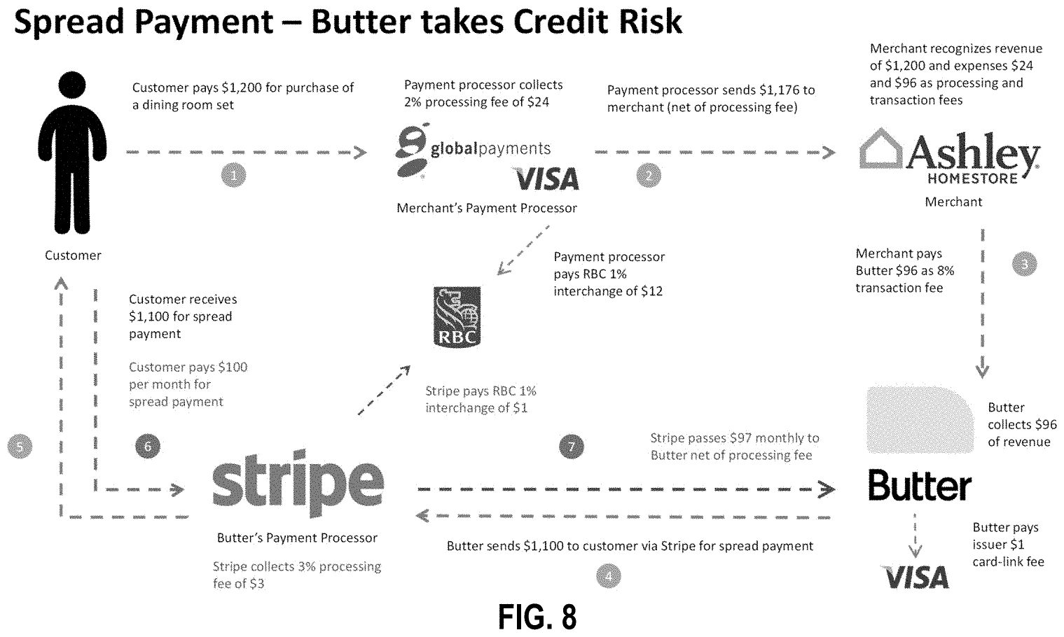

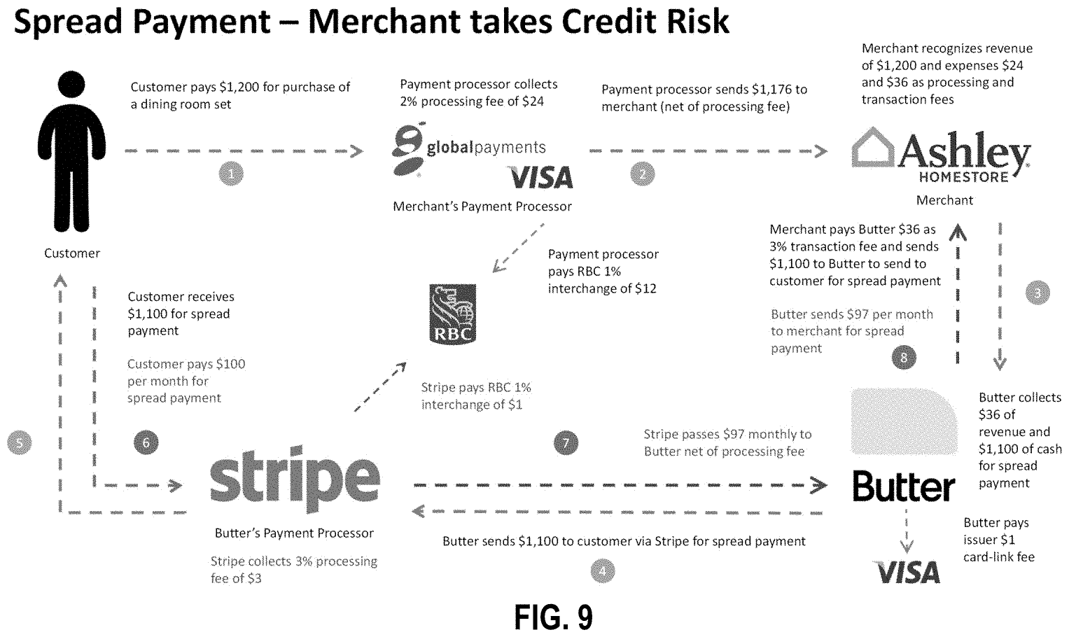

FIG. 1D is a flowchart showing aspects of an example method for processing electronic transactions.

FIG. 2 shows an example subscription process using the example system, in accordance with one embodiment.

FIG. 3 shows an example spread process using the example system, in accordance with one embodiment.

FIG. 4A shows an example flow of funds when the system takes the risk, in accordance with one embodiment.

FIG. 4B shows an example flow of funds when the merchant takes the risk, in accordance with one embodiment.

FIG. 5A shows an example process for merchant registration, in accordance with one embodiment.

FIG. 5B shows an example consumer pre-registration process, in accordance with one embodiment.

FIG. 5C shows an example consumer transaction process for a spread payment plan, in accordance with one embodiment.

FIG. 5D shows an example consumer payment process for a spread payment plan, in accordance with one embodiment

FIG. 6 shows an example consumer transaction process for a subscription payment plan, according to some embodiments.

FIG. 7 shows an example consumer payment process for a subscription payment plan, in accordance with one embodiment.

FIG. 8 shows an example schematic diagram for spread payment, in accordance with one embodiment.

FIG. 9 shows another example schematic diagram for spread payment, in accordance with one embodiment.

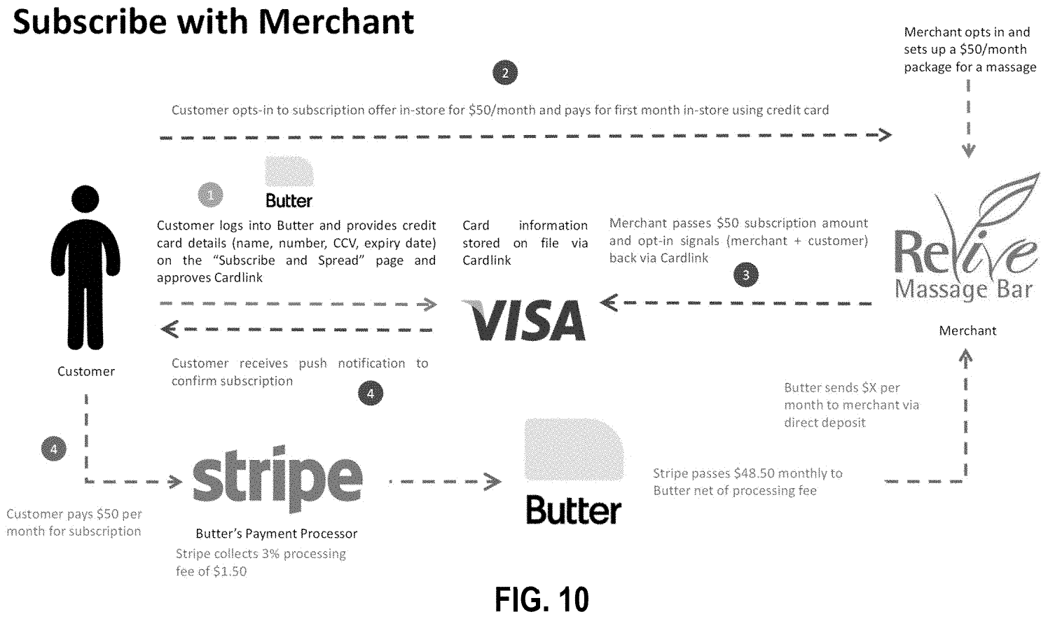

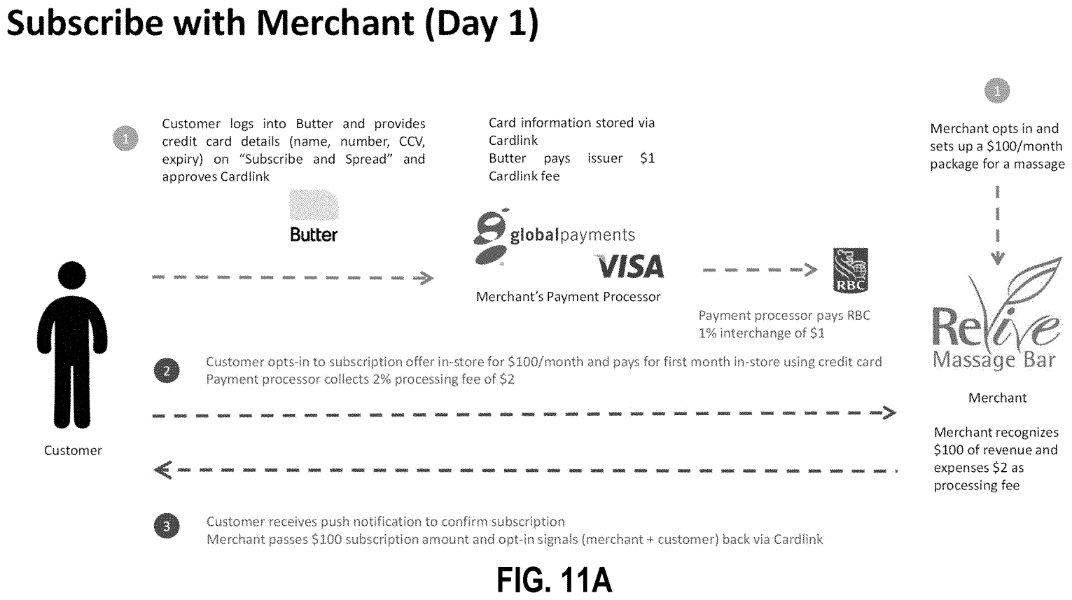

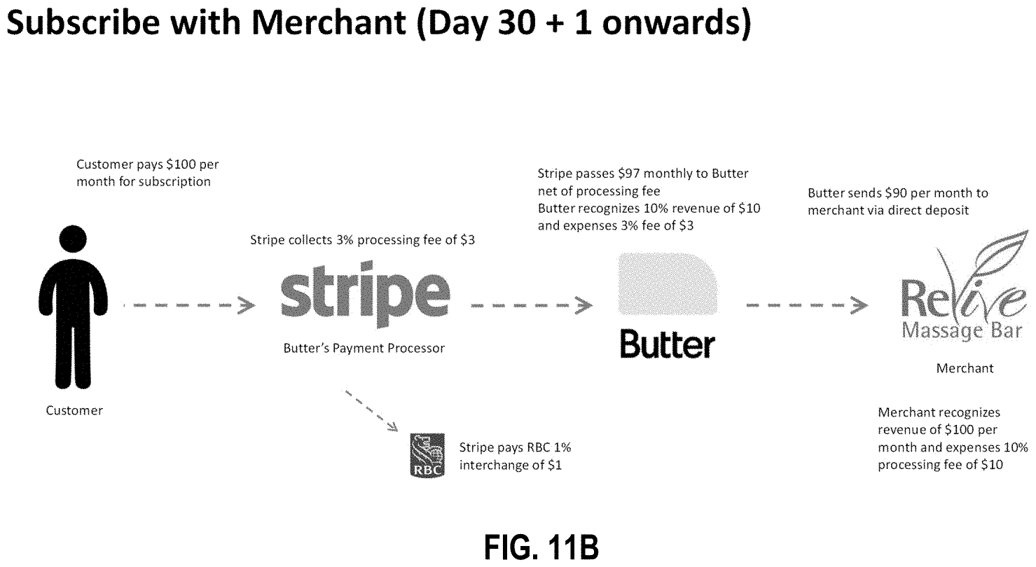

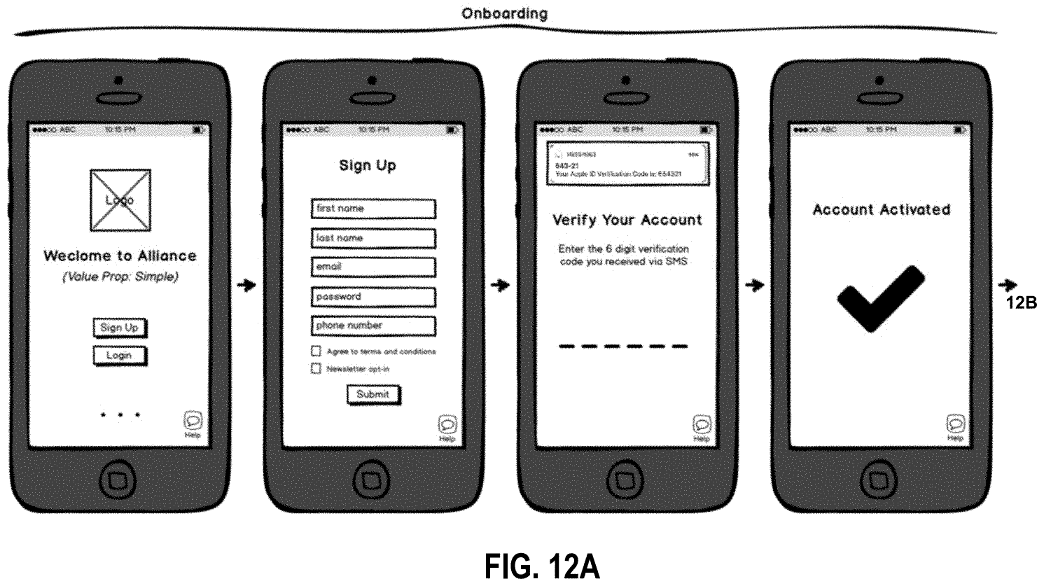

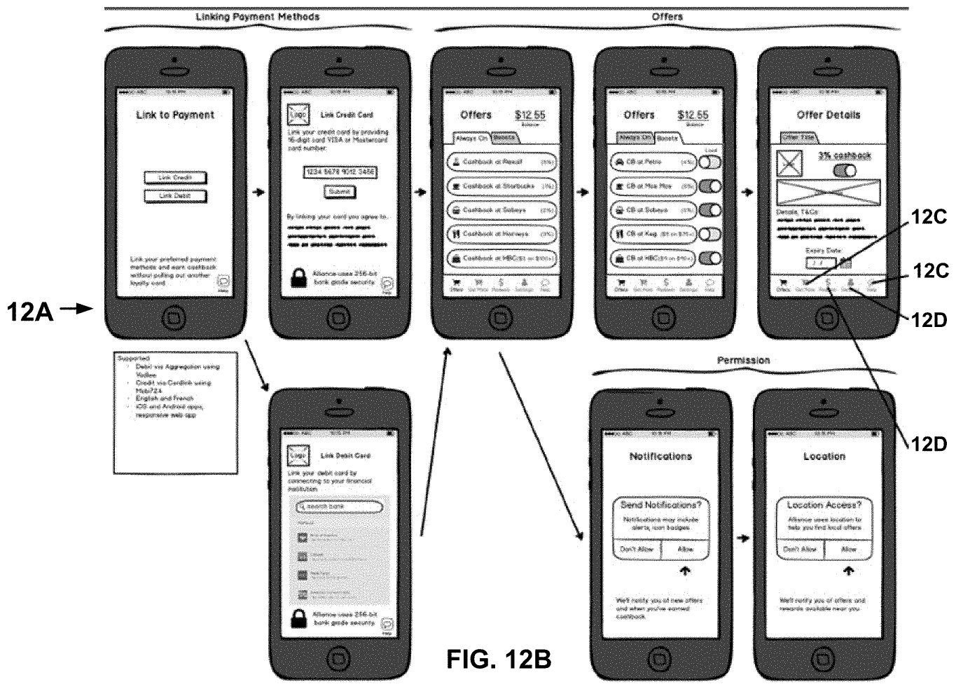

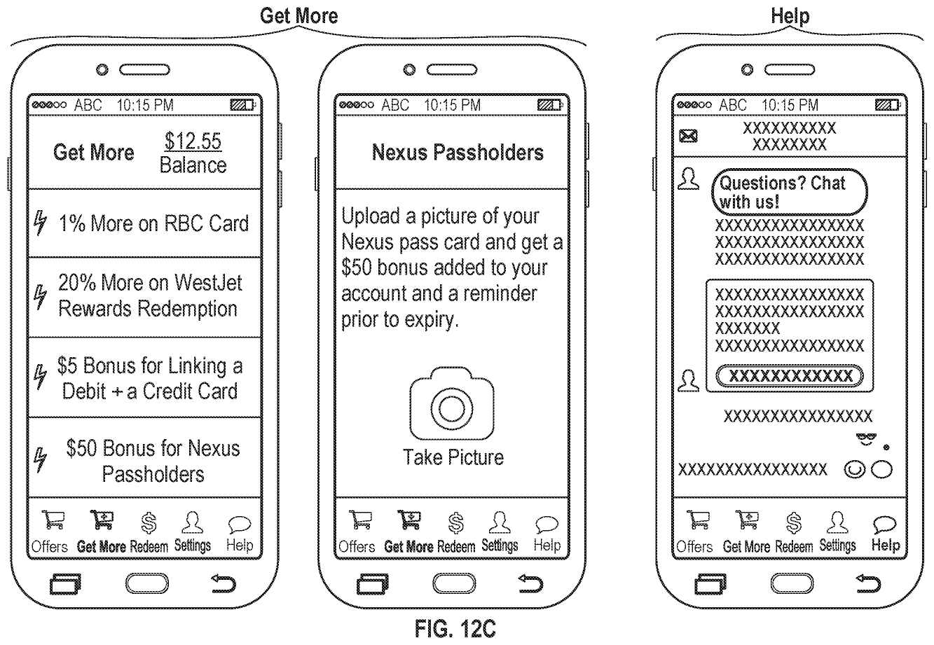

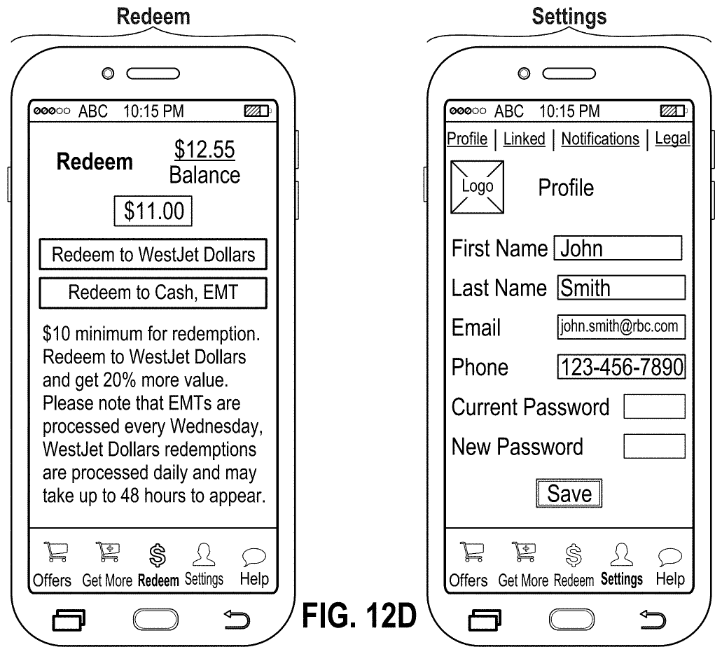

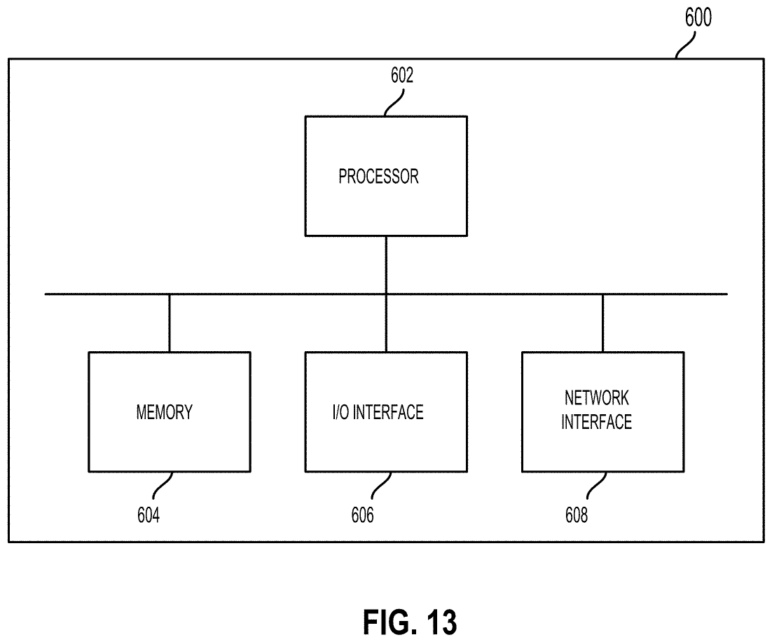

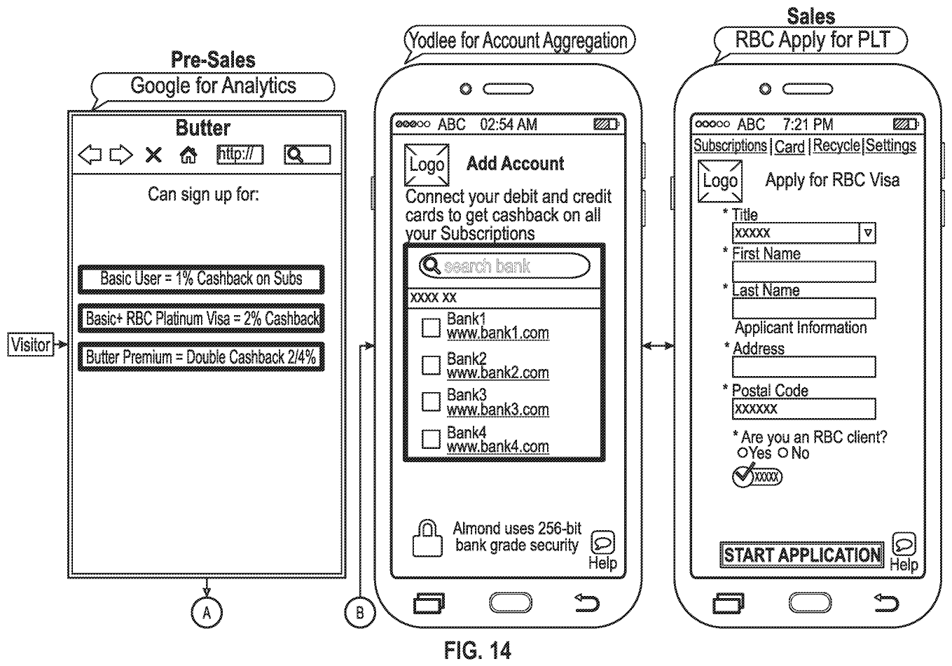

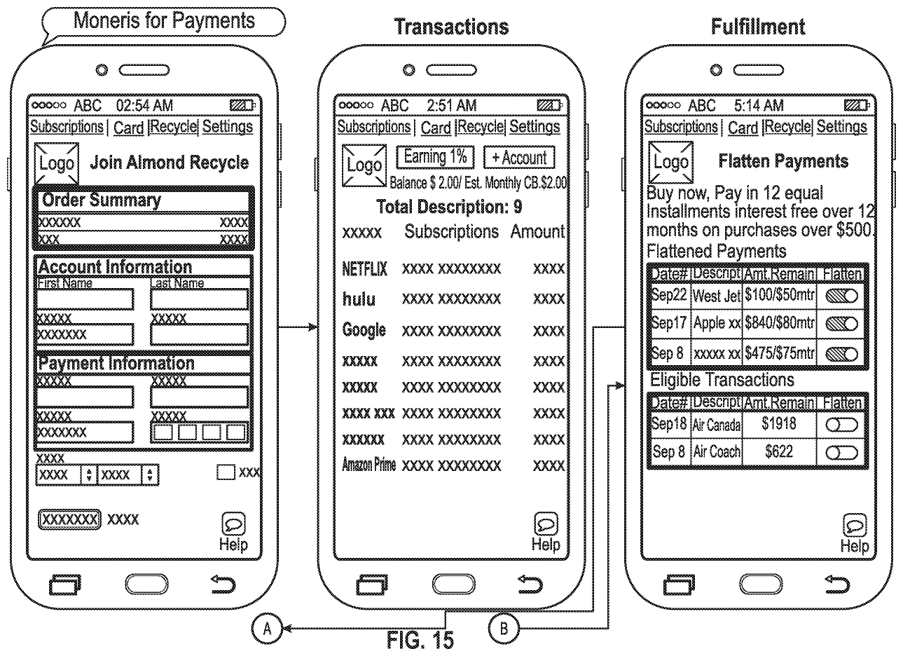

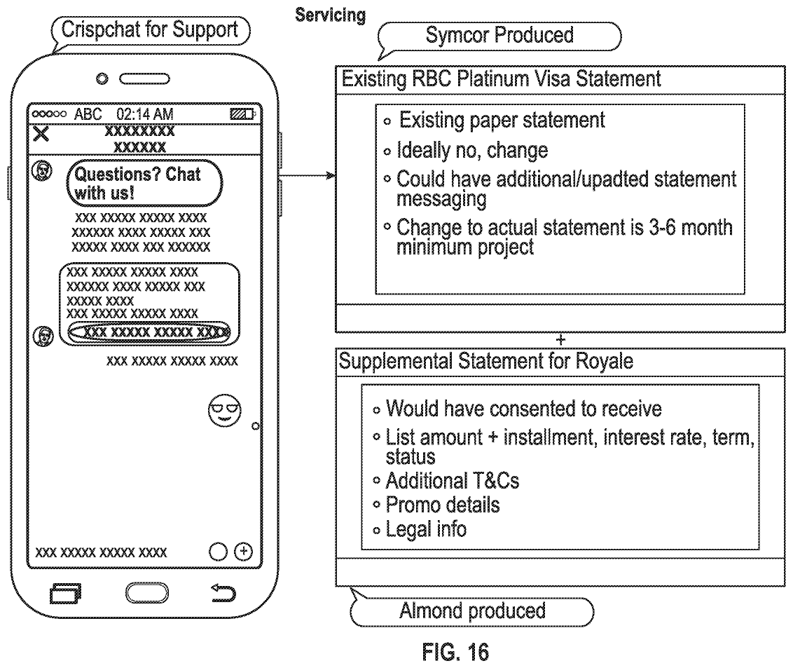

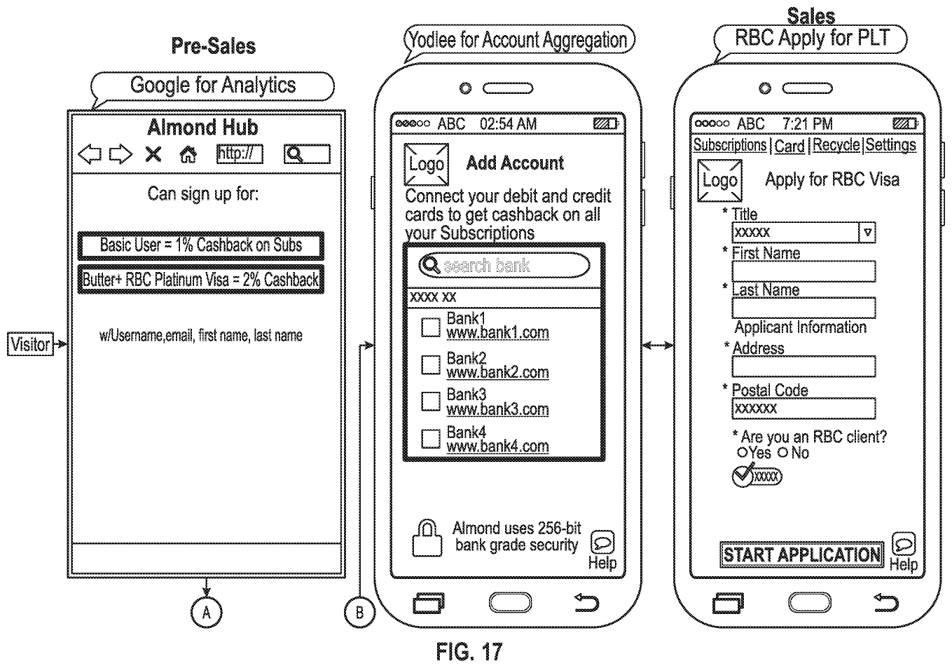

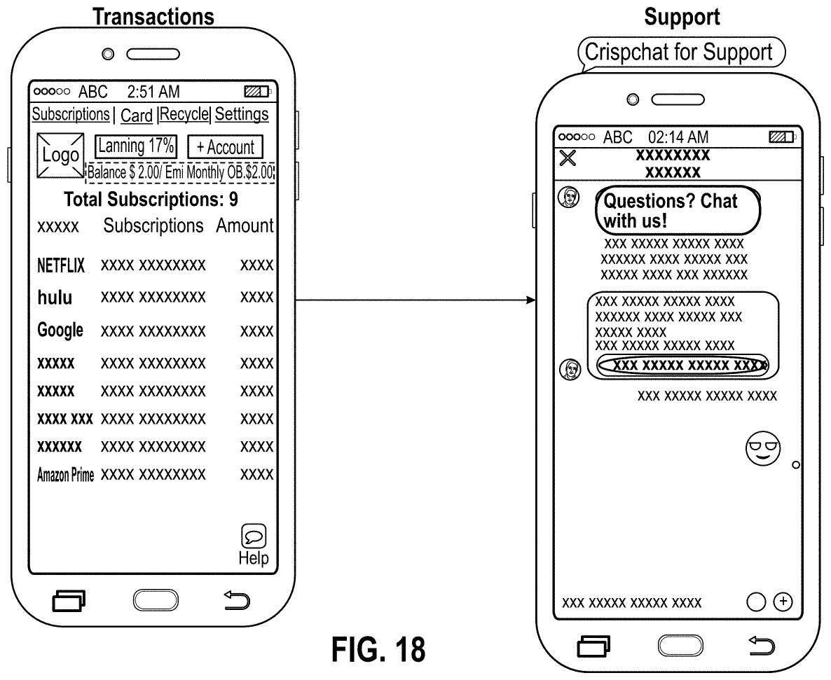

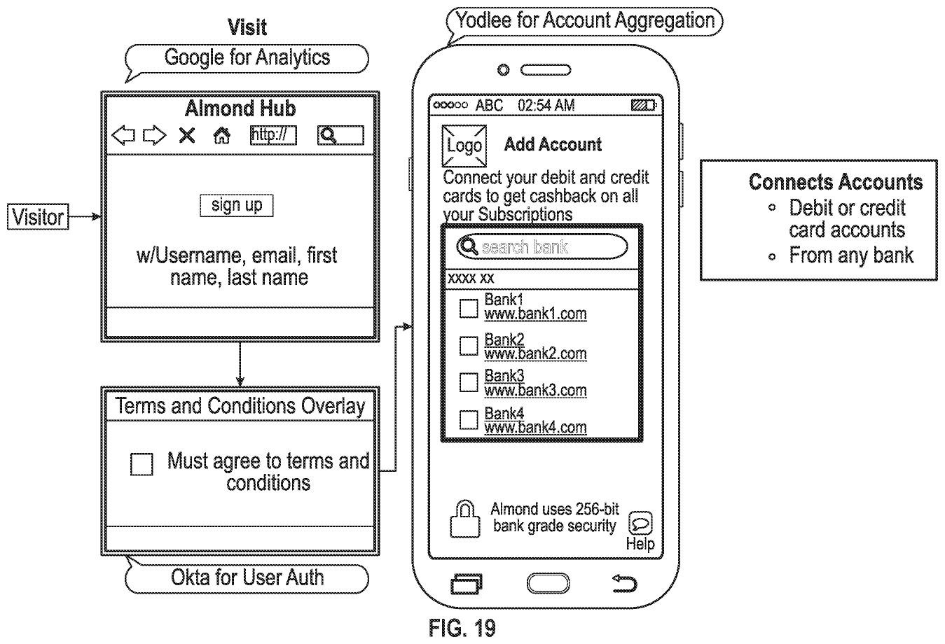

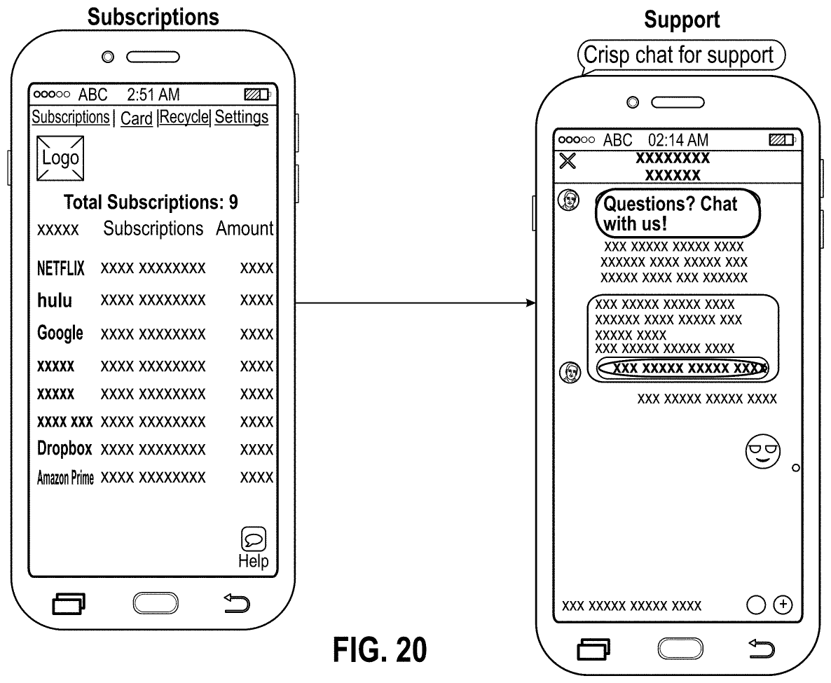

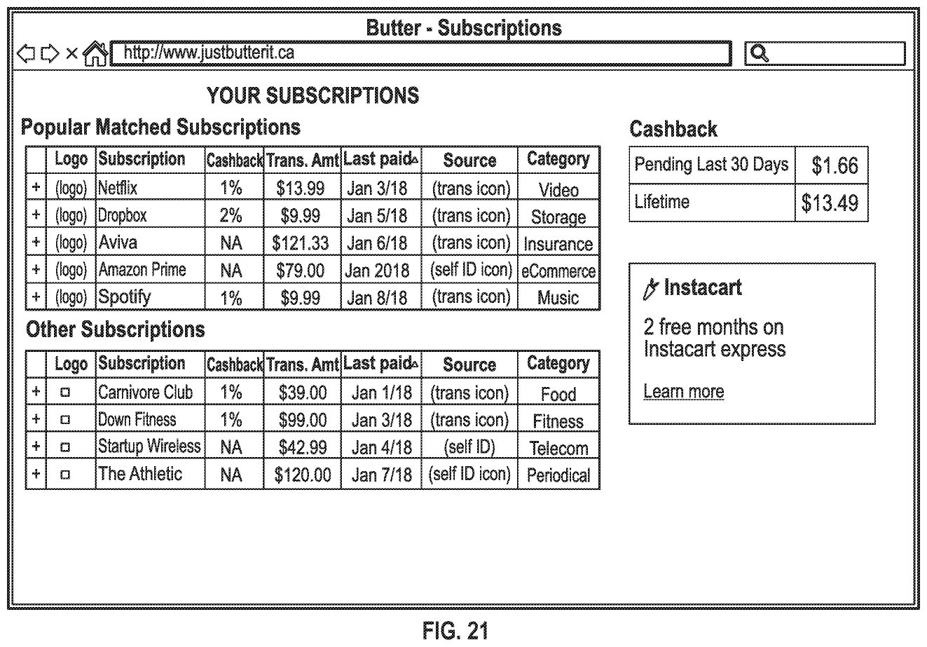

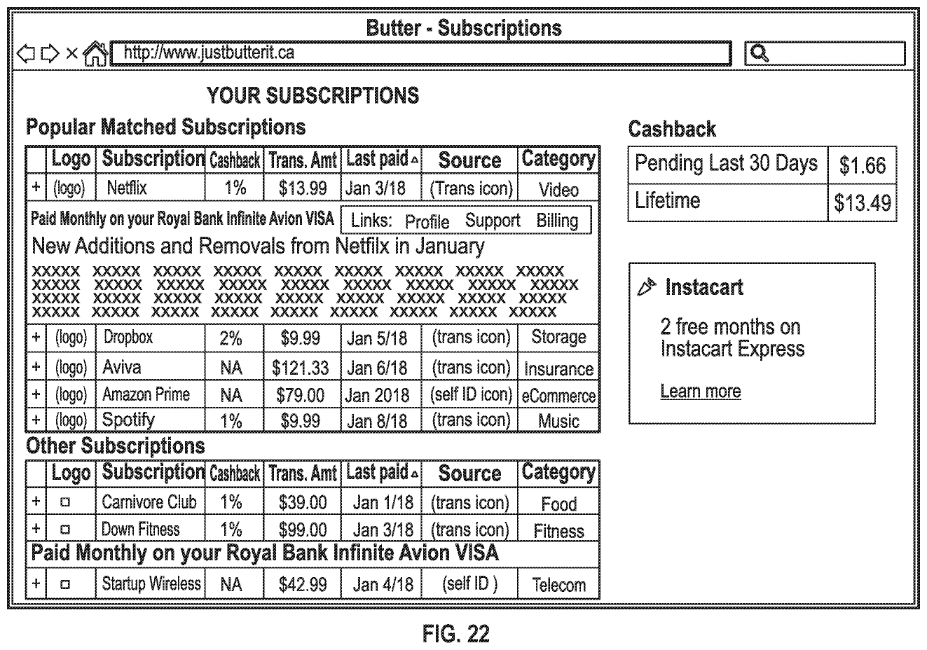

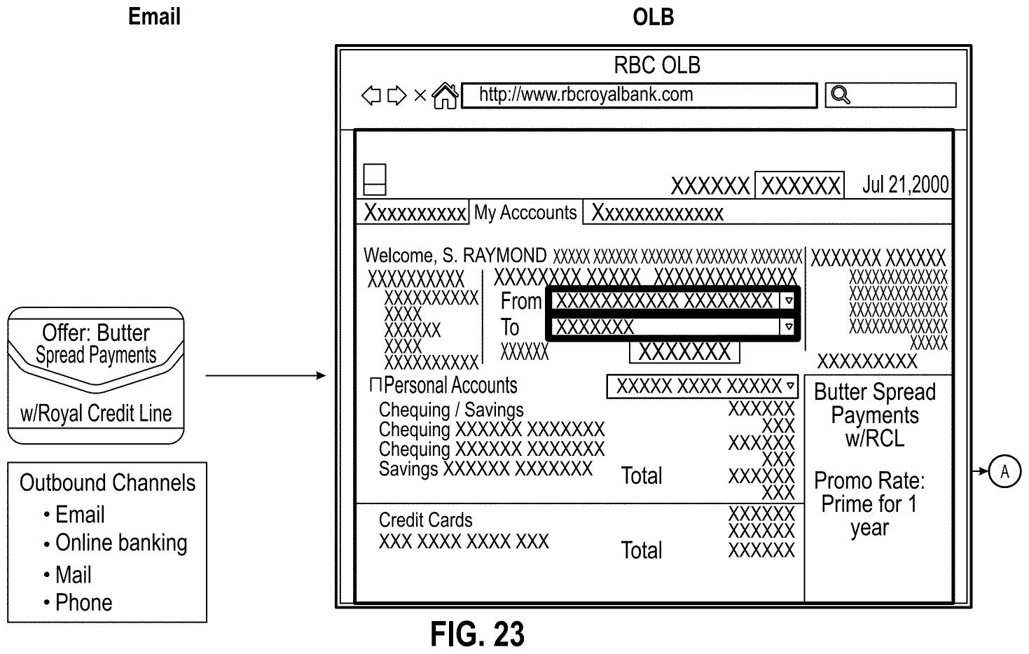

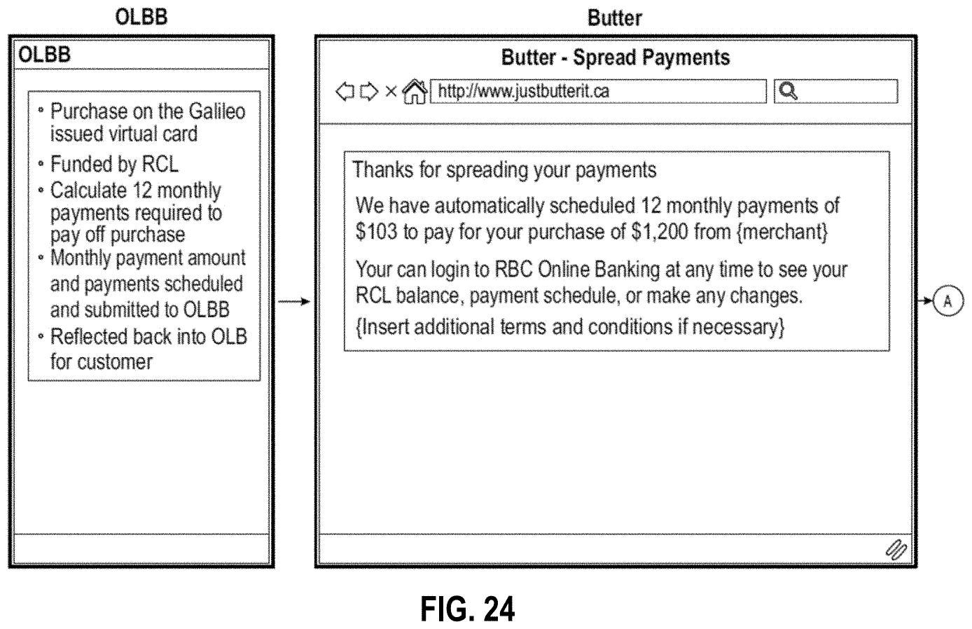

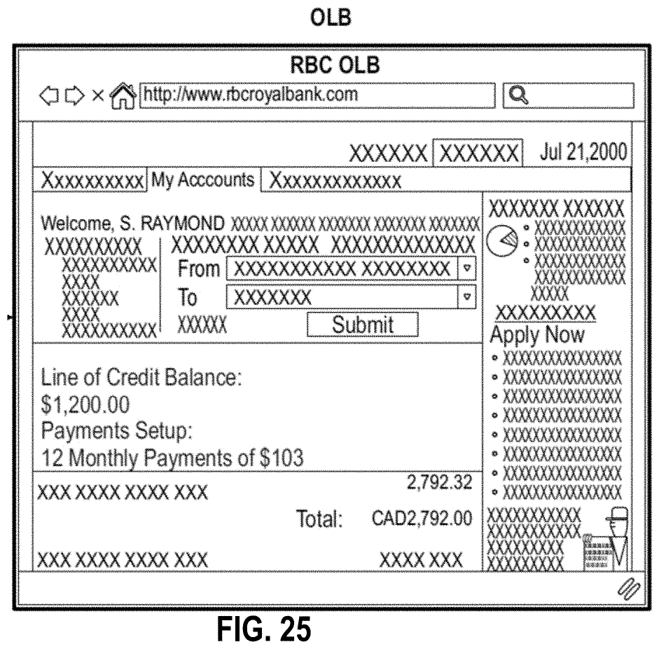

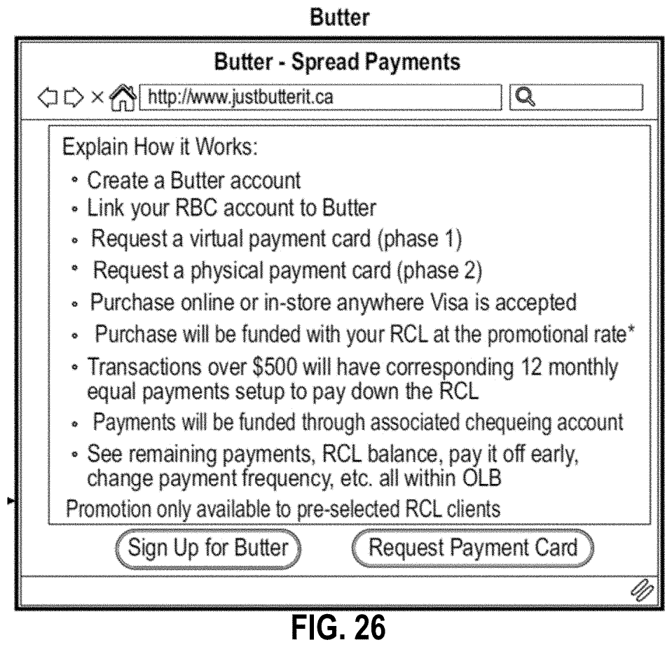

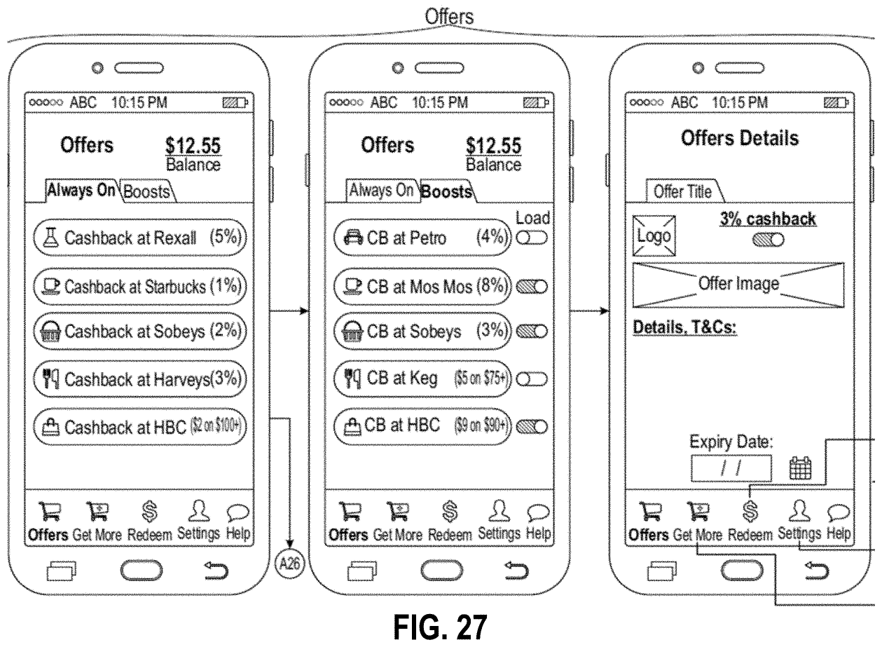

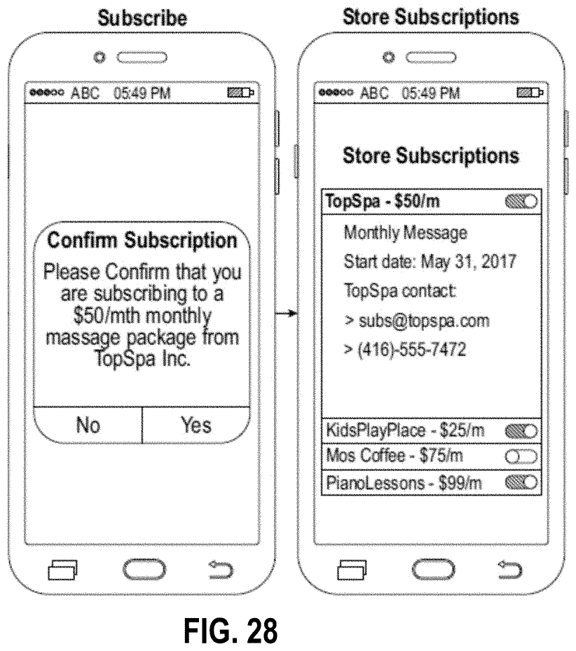

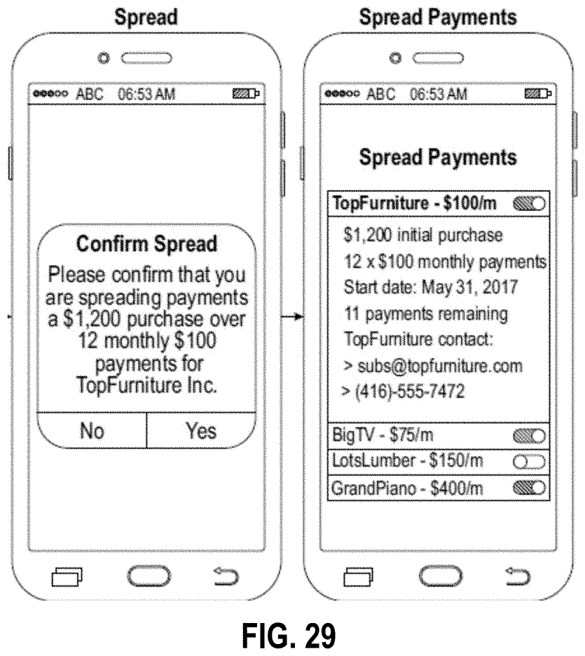

FIG. 10 shows an example schematic diagram for subscription with a merchant, in accordance with one embodiment.

FIG. 11A shows an example schematic diagram for subscription with a merchant on day 1, in accordance with one embodiment.

FIG. 11B shows an example schematic diagram for subscription with a merchant post day 30, in accordance with one embodiment.

FIG. 12A shows an example onboarding process for a consumer, in accordance with one embodiment.

FIG. 12B shows an example transaction on a mobile device, in accordance with one embodiment.

FIG. 12C shows part of a transaction including offers for a transaction, in accordance with one embodiment.

FIG. 12D shows another part of a transaction including offer redemption for a transaction, in accordance with one embodiment.

FIG. 13 is a schematic block diagram of an example computing device implementing system.

FIGS. 14, 15, 16, 17, 18, 19, 20, 21, 22, 23, 24, 25, 26, 27, 28 and 29 show example user interfaces.

### DETAILED DESCRIPTION

Embodiments of methods, systems, and apparatus are described through reference to the drawings.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various example embodiments described herein.

FIG. 1A is a schematic block diagram of a physical environment for a system 100 for processing electronic transactions.

System 100 may be software (e.g., code segments compiled into machine code), hardware, embedded firmware, or a combination of software and hardware, according to various embodiments.

Today, financial transactions including transactions made with credit or debit cards are generally processed in real time or near real-time. A customer typically has to pay for a product or a service in full at Point-of-Sale (POS), such as at a furniture or grocery store, unless a special payment plan is arranged. Arrangement of such a payment plan tends to be time consuming and requires involvement of paper work and other steps.

System 100 is configured to receive a set of transaction data associated with an original transaction at a merchant POS 160. The transaction data may include an electronic token. System 100 may process the transaction data in order to determine if the transaction is appropriate for a subscription or a spread transaction with the merchant, and subsequently send a notification to a mobile device 140 through a mobile application associated with the consumer associated with the transaction via network 130 to start the process for a subscription or spread transaction. The subscription or spread transaction may be processed by one or more payment processor 150.

A subscription transaction may refer to a transaction that involves multiple payments over a course of period, and in some embodiments, the subscription transaction may include the first payment of the multiple payments over the period, and every subsequent payment after may be of an equal amount to the payment amount in the first payment. A subscription payment plan may refer to the entire payment schedule of the multiple payments. The payment plan may also refer to the implementation of the payment schedule. In some embodiment, the subsequent payment amount may vary from the initial payment, or vary from each subsequent payment. For example, a first payment may be $10, a second payment may be $12, and so on.

As described herein or otherwise, for a subscription, in some embodiments, the processor is configured to receive information for linking a credit card through a program (e.g. Butter) either directly through the credit card payment processing system or via a third-party card link provider or API (e.g. Fidel™). In some embodiments, the registration process authorizes the pass-through of transaction data from specific merchants, from a specific issuer, in a specific merchant category code, or any other variation or combination.

The (Butter) processor Butter receives a unique identifier representing that specific card issued by the card network or third party card-link provider.

When a user purchases item in-store and pays through the payment terminal (for example Moneris Chip and Pin for a Visa card), just like a regular transaction, one or more data processing tasks validate the payment card, check credit available, and process payment.

In some embodiments, the (Butter) processor receives a notification via webhook indicating a users' card has been charged with data which can includes merchant ID, time, payment amount, etc. The processor analyzes the merchant ID, time, payment amount data etc. to see if matches a subscription plan defined by the merchant during their onboarding with Butter.

The processor user the merchant data and transaction data to make a decision to offer a spread payment/subscription plan. In some embodiments, as an alternative, the platform may be able to make other loan decisions based off transaction data from the card linked user.

The processor sends a notification to an end user through email and/or SMS and/or iOS™ push notifications systems and/or Android™ push notification systems.

Signals are generated to display the notifications/user interfaces and the end user clicks on the notifications, then clicks to agree to turn into a subscription plan. The End User agrees to payment terms and initiates a payment frequency plan by providing credit card details (name, number, expiry, CVV, possibly address) to an online payment process, ie: Moneris.

The payment processor can verify the credit card details with the payment networks (Visa, Mastercard, etc.) and sends back a valid token representing the credit card to be stored by the Butter server.

At the agreed upon payment frequency, Butter server runs a payment frequency script at the specified payment intervals and sends the token to the payment processing system to process the recurring subscription transaction. The transaction is processed, card issuer releases the payment and Butter receives the payment less fees from the payment networks, acquirers, and processors.

A spread transaction may refer to a transaction that involves multiple payments over a course of period. In some embodiments, the multiple payments may have a total payment amount equal to the amount set in the transaction. In some embodiments, the total payment amount may be equally divided among the multiple payments over the period. A spread payment plan may refer to the entire payment schedule of the multiple payments. The payment plan may also refer to the implementation of the payment schedule. In some embodiments, the multiple payments may be of different amounts, and they may include additional payments that are not previously included in the total payment amount.

In some embodiments, system 100 may provide consumers with a free service and/or a paid service. In some embodiments, system 100 may be configured as a web-based platform where users (e.g. consumers) can link their payment cards (credit or debit cards, for example) so that system 100 can identify subscription-related payments on those cards (e.g., Netflix™, Hulu™, Amazon Prime™, etc.), display the subscription-related payments in a web-based platform, and provide cashback for the various subscription-related payments.

In some embodiments, a user may receive a certain percentage of cash back (e.g. 1%) for any subscription-related payments made using one or more types of payment cards (e.g. a premium credit card), or 1% cash back for subscription-related payments made using any other card.

In some embodiments, a user may pay an annual fee to receive double the cash back (e.g. 4% for premium credit cards, 2% for other cards) and also enjoy the benefit to flatten a purchase over 12 months at 0% interest. Sometimes the purchase amount has to be over a minimum amount (e.g. over $500) in order to be eligible to be flattened.

In some embodiments, system 100 may analyze the set of transaction data to determine a credit card profile associated with the electronic token, analyze the set of transaction data to identify when the original transaction is a subscription transaction or a spread transaction with a merchant, send an electronic notification to a user associated with the credit card profile with information regarding the subscription transaction or the spread transaction, and upon receiving a confirmation from the user representative of an agreement to the subscription transaction or the spread transaction, process the set of transaction data to generate new transaction data based on the subscription transaction or the spread transaction.

In some embodiments, a token is a set of characters that represent or are otherwise mapped to a card number.

In embodiments, a subscription trigger condition can be based on any number or combination of values including: unique MID (merchant ID), location associated with MID, description text, could also be terminal IDs, date stamp, time of day, etc.

In another aspect, the original transaction is the spread transaction, and the new transaction data comprises data required to generate a refund for the user and data required to generate a subsequent payment authorization equivalent to an amount of the refund. The refund may represent a credit or debit to a user's account, depending on if the refund is credited to the user's bank or credit account, or debited from the user's bank or credit account.

In yet another aspect, the original transaction is the subscription transaction, and the new transaction data comprises data required to generate one or more subsequent payment authorizations based on the subscription transaction.

In still another aspect, the set of transaction data includes at least one of: credit card digits, credit card owner, Card Verification Value (CVV), merchant name, merchant ID, merchant location, merchant contact details, payment details, merchant category, transaction ID, SKU, transaction amount, transaction currency, a bank identification number (BIN) and an Authorization Code.

In one aspect, the method may include receiving a set of user registration data comprising information regarding the credit card profile and registering the credit card profile based on the user registration data.

In another aspect, the method may include receiving a set of merchant registration data comprising information regarding the merchant.

In still another aspect, the merchant registration data comprises at least one of: merchant name, merchant ID, merchant location, merchant contact details, merchant category, payment details and an offer.

A processor or processing device 104 can execute instructions in memory 108 to configure various components or units 116, 117, 118, 119, 120. A processing device 101 can be, for example, any type of general-purpose microprocessor or microcontroller, a digital signal processing (DSP) processor, an integrated circuit, a field programmable gate array (FPGA), a reconfigurable processor, or any combination thereof.

Each communication interface 106 enables the system 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. W-Fi, WMAX), SS7 signaling network, fixed line, local area network, wide area network, and others, including any combination of these.

Each I/O unit 102 enables the system 100 to interconnect with one or more input devices, such as a keyboard, mouse, camera, touch screen and a microphone, or with one or more output devices such as a display screen and a speaker.

Data storage 110 can be, for example, one or more NAND flash memory modules of suitable capacity, or may be one or more persistent computer storage devices, such as a hard disk drive, a solid state drive, and the like. In some embodiments, data storage 110 comprises a secure data warehouse configured to host user profile data.

Memory 108 may include a suitable combination of computer memory such as, for example, static random-access memory (SRAM), random-access memory (RAM), read-only memory (ROM), electro-optical memory, magneto-optical memory, erasable programmable read-only memory (EPROM), and electrically-erasable programmable read-only memory (EEPROM), Ferroelectric RAM (FRAM) or the like.

A user registration unit 116 may be configured to process user registration for one or more consumers. In some embodiments, a consumer may use a mobile application 140 installed on a mobile device to start the registration process. In some embodiments, the consumer may enter appropriate information regarding a credit card in order to register himself in the programme offered by system 100.

A merchant registration unit 117 may be configured to process merchant registration process for one or more merchants. In some embodiments, a merchant may register with system 100 so that when a consumer makes a transaction at the merchant POS 160, system 100 may receive the corresponding transaction data in order to analyze the data for subscription or spread payment process.

A mobile application unit 118 may be configured to provide a mobile application 140 at a mobile device over network 130. The mobile application 140 may be configured to provide an user interface via mobile device to the consumer. The mobile application unit 118 may cause system 100 to connect to external databases and systems. In some embodiments, instead of a mobile application, a user may register and access the system through SMS services, a web-portal, or through a financial institution's website.

A transaction analytics unit 119 may be configured to perform data analytics based on received transaction data. For example, transaction analytics unit 119 may parse the transaction data and based on the data type and values in the transaction data, determine if the associated transaction is appropriate for a subscription or spread payment plan.

Payment unit 120 may be configured to provide and facilitate, when appropriate, payment plans for a consumer when the consumer signs up for a subscription or spread payment plan. The payment unit 120 may be configured to contact payment processor 150 and merchant POS 160 in order to transmit and receive payments.

In some embodiments, system 100 may include an API unit (not illustrated) configured for providing or facilitated an interface, such as a user interface, to connect to external databases and systems.

FIG. 1B shows a schematic diagram showing aspects of an example system 1100 for processing an electronic transaction. Aspects of FIG. 1A and FIG. 1B can overlap, be interchangeable, and/or be alternatives to each other. Suitable variations, combinations and/or alternatives of FIGS. 1A and 1B can also be used.

The system 1100 can include a transaction initiating device 1310 such as, for example, a point-of-service terminal, a computer, a mobile device, a cash register, an automated teller machine, or any other wired or wireless device suitable for generating and/or communicating transaction data to one or more computing systems such as an electronic resource management system 1101.

The electronic resource management system 1101 can be any combination of systems, servers, computers, or other devices for processing a transactions and/or otherwise managing electronic resources such as electronic representations of funds. The electronic resource management system 1101 can include one or more processors located across any number of systems or devices, and at any number of locations.

The electronic resource management system 1101 can include any number of networking, data storage and/or processing devices. These devices can include computer-readable media, processors and/or network communication modules for communicating within the electronic resource management system 1101 as well as with external devices or systems such as transaction processing systems 1350 (e.g. credit card processing systems, acquiring bank systems, card issuing systems, systems associated with other financial institutions, etc.). In some embodiments the electronic resource management system 1101 can be part of, include and/or operate in conjunction with a transaction processing system 1350.

The transaction processing system 1350 can, in some examples, include a payment processor or interchange network system 1330 such as a credit or debit card network. The transaction processing system 1350 can include any number of networking, data storage and/or processing devices. These devices can include computer-readable media, processors and/or network communication modules for communicating within the transaction processing system 1350 as well as with external devices or systems.

The system 1100 can, in some examples, include a merchant system 1140, and one or more user devices 1102. The various devices and components in the system 1100 can be connected by one or more networks 1305. These networks 1305 can include any combination of private, public, wired, wireless or any other network suitable for transmitting communications between the system devices and components.

While the various systems and devices in FIG. 1B are illustrated as separate components, the distinction between these systems and devices may not be clear as aspects of one system/device may be shared with or may be completely contained within another system/device. It should be understood that the physical or logical distinction between these components may and need not be clear.

The system 1100 can include one or more data storage device(s) 1133 as described herein which can be used to store data regarding electronic resource quantities (e.g. dollars) associated with one or more accounts. In some embodiments, the one or more data storage devices 1133 store data regarding user resource pools. In some embodiments, user resource pools include one or more groupings of resources which can be consumed or otherwise used to execute data processing tasks. In some embodiments, user resource pools can represent one or more accounts for storing electronic funds (i.e. resources) which can be used to execute data processing tasks associated with one or more financial transactions.

In some embodiments, the data storage device(s) 1133 can include store parameters for one or more electronic transaction data processes. These electronic transaction data processes can include data processes which when executed transfer, increase and/or decrease electronic resources associated with an electronic account/resource pool.

These device(s) can be part of a device such as a computer-readable medium in a computer, server or mobile device, or can be separate storage devices. In some examples, the data storage device(s) 1133 can be physically or logically shared, mirrored, spread across, or otherwise located across multiple system(s)/device(s).

In some examples, the data storage device(s) 1133 can store merchant and/or customer data.

In some embodiments, the computing system 1101 and/or the user device(s) 1102 include one or more processors and computer readable code for presenting dynamic user interfaces to end users who can be associated with electronic accounts stored or otherwise accessible by the computing system 1101. In some embodiments, the user interfaces can be hosted by a web or other server at or associated with the computing system 1101, which can be accessed via a web browser or application (e.g. mobile banking application) installed at a user device.

In some embodiments, the system 1100 is configured to provide an electronic transaction platform which provides technical data processes to enable transactions between accounts, and can cause a data processing task to be divided, replicated or to otherwise generate child data processing tasks associated with the original or parent data processing task.

FIG. 10 shows aspects of an example method for managing resource consumption for electronic transaction data processes and/or for executing one or more data processing tasks for one or more electronic transactions.

In some embodiments, aspects of FIGS. 10 and 1D can be performed by one or more processors without modification to any merchant systems and/or payment processing systems. In some embodiments, aspects of these figures can also be performed or processors external systems associated with legacy financial institution activities. For example, one or more processors configured to execute aspects of FIGS. 10 and 1D can be at physical or logical locations which are separate from merchant, payment processor, and/or acquirer systems.

References to activities by a processor should be understood to include activities by one or multiple processors.

At 2001, as described herein or otherwise, the processor is configured for receiving an electronic transaction data set including parameters associated with a first data processing task for executing an electronic transaction. For example, as described herein or otherwise, a data processing task for executing an electronic transaction such as making a payment from a consumer account at a merchant point of sale device can include signals or instructions for consuming a quantity of an electronic resource from the consumer resource pool (e.g. withdrawing funds from an account associated with the consumer). The data processing task can also include signals or instructions for transferring a quantity of an electronic resource from the consumer resource pool to a merchant resource pool, or to deduct or consume the electronic resource from the consumer resource pool and to increase the corresponding quantity of the electronic resource in the merchant resource pool.

In some embodiments, the data processing task can also include signals or instructions for processing refunds, processing pre-authorizations or holds on available funds, and/or any other electronic transaction.

In some embodiments, the parameters include at least one parameter identifying a quantity of an electronic resource consumed from a purchaser resource pool by the data processing task.

In some embodiments, the electronic transaction data set can be received by the processor from a component of the electronic transaction processing system such as a merchant point of sale device or system, a payment network system (such as the Visa™, MasterCard™, Interac™, or other payment network), and/or a financial institution system associated with the consumer and/or the merchant.

In some embodiments, the electronic transaction data set can be received when a payment authorization request is being sent (i.e. before the transaction has been approved). In some embodiments electronic transaction data set can be received after an authorization has been approved.

In some embodiments, the electronic transaction data set can be received from electronic payment platforms such as WeChat™, PayPal™, gift card processing systems, and/or any other suitable platform.

In some embodiments, electronic transaction data set can include a quantity of the electronic resource being consumed by the data processing task, a payment token or other identifier associated with the consumer, a merchant identifier, a merchant category code, location information, date/time information, transaction type, and/or any other data associated with an electronic transaction and/or the parties involved, or any subset or combination thereof.

At 2002, as described herein or otherwise, the processor is configured for generating signals for communicating an electronic message to a destination associated with the purchaser resource pool. For example, in some embodiments, the processor is configured to send signals to a device associated with the purchaser profile such message to a wallet or baking application, web browser or any other application on the device associated with the purchaser profile. In some embodiments, signals can communicate to a web or other electronic service (e.g. online banking) which communicates the message when a user is logged on to the service. In some embodiments, the communication can be via text message, email or any other communication mechanism.

In some embodiments, the electronic message communicates an option for deferring execution of at least a portion of the data processing task thereby deferring a corresponding consumption of at least a portion of the quantity of the electronic resource from the purchaser resource pool. In some embodiments, the option can be a single option such as the option to split a large transaction into 12 smaller monthly transactions. In some embodiments, the message communicates multiple options one or more (or none) of which can be selected by the user.

In some embodiments, the options can be defined by the lender and/or may be conditional on one or more of the parameters. For example, purchases over different thresholds can be allowed different quantities, frequencies and number of data processing task. In another example, a purchase anywhere over $500 can install a purchase for 12% APR, however, if a purchase having a specific merchant ID associated with a special merchant offer, the installment can be 0% APR for 12 monthly payments.

In some embodiments, the options can be presented by signals which trigger the display of a user interface at a device associated with the purchaser resource pool. The user interface enabling selection of one or more options for disbarring execution of at least a portion of the data processing task. For example, the user interface can allow for selection of how many smaller data processing tasks to generate, quantity of resource to be consumed by each of those smaller data processing tasks, and/or the timing or periodicity of when those smaller data processing tasks are to be executed.

In some embodiments, the device associated with the purchaser resource pool can be a device associated with a phone number or other identifier associated with the purchaser profile, a device on which the user is logged on or otherwise authenticated with one or more services to which the processor may be linked or otherwise receive an indication that the purchaser is at that device, etc.

At 2003, as described herein or otherwise, the processor is configured to receive response signals indicative of instructions to defer execution (e.g. receive user input or a response message to defer execution) of at least at portion of the original data processing task. Upon receiving these signals, in some embodiments, the processor is configured to generating a second data processing task for releasing at least the portion of the electronic resource to the purchaser resource pool. In some embodiments, the second data processing task releases or otherwise increases, in the purchaser resource pool, a portion of the electronic resources consumed by the original transaction.

In some embodiments, the processor configured for generating one or more deferred child data processing tasks for executing at least the portion of the data processing task at one or more future times; when executed, the one or more deferred child data processing tasks consuming at least the portion of the quantity of the electronic resource from the purchaser resource pool.

In some situations, this may use or otherwise alleviate a sudden large consumption of resources by a single data processing task, and replace it with a number of smaller data processing tasks spread over a longer period of time. In some situations, this may relieve short-term constraints on resources.

In some embodiments, the parameters associated with the data processing task include a payment token, and the processor is configured for identifying a user data profile associated with the payment token (for example, from a database or otherwise multiple data profiles stored at a data storage device). In some embodiments, the processor is configured for determining the destination to which the electronic message is to be communicated based on a destination associated with the first user data profile. For example, the destination may be a device, address or profile for a messaging service, IP address, and/or any other destination associated with the user's data profile.

In some embodiments, the child data processing tasks can be data processing tasks for executing electronic transactions consuming smaller quantities of resources. For example, if an original data processing task is based on an electronic transaction for $1000, 10 child data processing tasks can be generated to execute electronic transactions for $100 each. In other embodiments, the quantities do not have to be the same for each child data processing task. In some embodiments, the child data processing tasks can be generated to execute at regular intervals, for example monthly. In other embodiments, the child data processing task to be generated at irregular intervals, and/or at specific times or dates.

In some embodiments, the child data processing tasks can be data processing tasks for reserving quantities of resources. For example, a data processing task can be a hold or preauthorization on funds in a purchaser resource pool. For example, for a $1000 purchase to be split into 10 installments, the processor can be configured to refund or otherwise release $900 of the original purchase, and to generate a child data processing task to reserve or put a hold on that $900 to ensure the resources are available at a future time. In some embodiments, the processor can be configured to generate 9 child data processing tasks each reserving $100. In some embodiments, the processor can be configured to generate child data processing tasks to consume the reserved resources.

In some embodiments, the reserve or hold on resources may expire after a defined period, so the processor can be configured to generate child data processing tasks to re-reserve or re-establish the hold on those resources after the defined period has elapsed.

In some embodiments, the processor can be configured to generate a child data processing task for executing the electronic transaction with a different account associated with the purchaser. For example, an original data processing task can withdraw funds from a credit card account, and corresponding child data processing tasks can release some of those funds to the credit card account, and process transactions against a bank line of credit or other account.

In some embodiments, the option for deferring execution of at least a portion of the data processing task is only communicated when the one or more parameters of the electronic transaction data set satisfy one or more deferral conditions. In some embodiments, a deferral condition can be satisfied when the quantity of the electronic resource consumed from a purchaser resource pool meets the threshold value, for example when a purchase is over a certain amount.

In some embodiments, a deferral condition can be satisfied when an identifier associated with the merchant involved in the electronic transaction matches one or more triggering merchant identifiers. For example, deferred execution may be enabled for a select list of merchant identifiers. In some embodiments, these may be merchants which have signed onto the program.

In some embodiments, a deferral condition can be satisfied when the merchant category code associated with the merchant involved in the electronic transaction matches one or more triggering merchant category codes. For example, deferred execution may only be enabled for transactions at furniture stores, travel agents, car dealerships, etc.

In some embodiments, registration data must be received by the processor before the method 2000 can function. In some embodiments, the processor receives a data set for a new user data profile. The new data set can include a payment identifier such as a credit card number or other identifier associated with a user resource pool.

In some embodiments, the processor sends a registration message including the payment identifier to a transaction processing system. For example, the processor can send a credit card number to the transaction processing system associated with the credit card. In some embodiments, the transaction processing system registers the payment identifier in its database such that whenever a data processing task involving that credit card number is executed at the transaction processing system, the data processing system matches the number with this list of registered numbers and communicates the corresponding electronic transaction data set to the processor.

In some embodiments, in response to the registration message the processor receives from the transaction processing system a response message including a payment token. In some embodiments this payment token is included in the electronic transaction data set sent to the processor when a transaction involving the registered credit card number is detected by the transaction processing system.

In some embodiments, the processor is configured to store the payment token in association with the new user data profile and delete the payment identifier. In some embodiments, by deleting the original payment identifier (e.g. credit card number) only using the payment token, the risk of the original payment identifier being intercepted or stolen may be reduced thereby potentially increasing security of the system.

In another approach, rather than the transaction processing system generating and communicating a payment token to the processor, the processor can send the registration message including the payment identifier and a payment token generated by the processor to the transaction processing system. Transaction processing system and then register these values in its database.

FIG. 1D shows aspects of another example method 3000 for managing resource consumption for electronic transaction data processes and/or for executing one or more data processing tasks for one or more electronic transactions.

At 3001, as described herein or otherwise, the processor is configured for receiving an electronic transaction data set including parameters associated with a first data processing task for executing an electronic transaction.

At 3002, upon determining from the parameters associated with the first data processing task for executing the electronic transaction satisfy a subscription condition, generating signals for communicating a subscription electronic message to the destination associated with the purchaser resource pool, the subscription electronic message communicating an option for triggering execution of a plurality of future data processing tasks for periodically consuming subscription quantities of the electronic resource from the purchaser resource pool.

For example, in some embodiments, the subscription condition is satisfied when a merchant identifier in the parameters matches a list of merchant identifiers associated with one or more merchants who have registered with the program. For example, a subscription condition can be satisfied when the merchant identifier identifies for example an hairdresser company which has registered with the system.

In some embodiments, the subscription condition is satisfied when additionally a resource quantity associated with the data processing task matches a defined value. For example, if a haircut regularly costs $50 in the hairdresser company offers a promotion for a $40 haircut if the consumer agrees to sign up for your monthly haircut subscription, the processor can be configured to satisfy the subscription condition when the parameters associated with the first data processing task indicate a quantity of $40 instead of $50.

At 3003, upon receiving subscription response signals indicative of a confirmation the option for triggering execution of a plurality of future data processing tasks for periodically consuming the subscription quantities, generating signals for initiating execution of the plurality of future child data processing tasks at one or more future subscription times.

FIG. 2 shows an example subscription registration process using system 100, in accordance with one embodiment. At step 210, a consumer may, through a user interface 145, use a mobile device to enter detailed information regarding a credit card. The details may include name, credit card number, expiry date, CVV. The consumer would agree to appropriate terms and conditions. Once submitted, the consumer may be registered as being interested in participating in the programs offered by system 100, such as a subscription or a spread payment plan. In some embodiments, for a consumer to use the services provided herein, said consumer may need to have a user account. A user account may be created by visiting a web page provided by system 100, inputting the user's credit card information (including name, credit card number, credit card expiry date, and CVV), providing permission to Cardlink to store said credit card on file, and agreeing to the terms and conditions therein.

Cardlink or card-linking, is a program which enables consumers to link their existing credit or debit cards to digital coupons, loyalty programs or mobile wallets. Using Cardlink in conjunction with credit card pre-authorization allows system 100 to provide and facilitate an electronic installment payment plan (e.g. a subscription or spread payment plan) without requiring a merchant POS to install any new software or hardware. System 100 may provide a seamless subscription or spread payment experience for a consumer and a merchant, as a merchant can use all their existing equipment and simply charge a customers' credit card, and in real time or near real time, have a consumer signing up for a subscription or a spread payment plan, often in the physical store, right after having made a transaction, as system 100 can push an electronic message directly to the user or engage with them to confirm the intent of the transaction soon after the transaction has occurred

In some situations, aspects of some embodiments may provide a seamless user experience as the system can operate in real or near real time such that notifications to the destination associated with the user profile can be communicated in a small amount of time. This amount of time can be a few seconds to a few minutes or any other period but may, in some situations, can feel seamless because the the amount of time required to recognize that a transaction has occurred on the merchant POS terminal leveraging the real time card-linking API provided by Visa or card network/payment network and/or third party provider, then making a decision to send the end user the option to spread their payment on their mobile device. This process can, in some situations, occur in seconds from the time the initial transaction is made.

A Merchant system also may need to register with system 100 in order to participate in the programs and payment plans offered by system 100.

At step 220, the consumer may visit a store to purchase a product or service and make a transaction at the merchant's POS. At step 230, system 100 may receive the corresponding transaction data from the merchant's POS, and determine that the transaction is suitable, or likely, a subscription transaction. System 100 may then send an electronic notification to the user's mobile device and confirm if the consumer (i.e., user) is subscribing to a payment plan, such as a monthly payment plan of $50 per month. At step 240, if the user confirms to participate in the subscription payment plan, system 100 may provide details regarding the subscription plan to the consumer via user interface 145. In some embodiments, the details regarding subscription plan may include type of product or service being rendered, a start date of the subscription plan, and contact information of the merchant. In some embodiments, a plurality of subscription plans may be in place at any given time for a consumer. In some embodiments, for in-store purchases, a merchant can set up a list of subscription plan offerings for customers (for example, $50/month message, $75/month haircut, etc.), and a user may purchase said subscription plan in store by, for instance, using a credit card payment terminal at a POS to complete a payment.

In some embodiments, these options are established by sending registration message to the processor, and storing subscription plan data sets. In some embodiments, the data sets can include a name, a monthly value, and a description. In some embodiments, the processor matches transaction data based on the value and merchant ID and generates a message to a destination associated with the consumer to confirm.

FIG. 3 shows an example spread process using the example system, in accordance with one embodiment. At step 310, for a user to use the services provided by system 100, the user may register for a user account. A user account may be created by visiting the Subscribe and Spread page, inputting the user's credit card information (including name, credit card number, credit card expiry date, and CVV), providing permission to Cardlink to store said credit card on file, and agreeing to the terms and conditions therein. A merchant may need to be signed up in order to participate. In some embodiments, instead of storing said credit card, Cardlink may store a token representing the credit card.

At step 320, for in-store purchases, a merchant may have signed up to participate and have set a minimum value for a spread payment and/or the minimum or maximum number of payments required. The merchant can inform consumers that it offers spread payments over the minimum amount prescribed. The user may purchase a product or service in store by, for instance, using a credit card payment terminal to complete a payment.

At step 330, as an example, a user may purchase a set of furniture in store for $1,200 and the payment is successfully processed on the user's credit card, which has been registered during step 310. Cardlink program can search for purchases over $200 and match an opt-in consumer with an opt-in Merchant. The user may receive a push message or e-mail on their mobile device in real-time or near real-time, asking for confirmation of the request to spread the payment over 12 months. Once user has agreed to the spread payment plan, Cardlink may send, or credit $1,100 back to the credit card, thus an initial payment of $100 is made. The credit card on file is then pre-authorized for the remaining value, $1,100, paid over 11 payments during the next 12 months.

At step 340, in some embodiments, the user account via an user interface may list active and inactive spread payments, which allows the consumer to make payments in-full at any time. The consumer can be billed on a monthly basis via a payment processor entity such as Stripe™. That is, the pre-authorized amount would decrease monthly by the amount of the monthly payment. The fund from the credit card may be sent to the merchant via appropriate payment method such as via direct deposit.

In some embodiments, the pre-authentication may not need to be decreased each month or each period if specific agreement has been reached between the system and the bank.

In some embodiments, the merchant may take the credit risk and pays a 2% fee of the full transaction value. The merchant may pay upward of 10% fee if the credit risk is instead taken up by system 100. In some embodiments, the consumer does not need to pay an interest fee, but system 100 may present the user with a “pay-what-you-want” tipping option.

FIG. 4A and FIG. 8 show an example flow of funds when the system takes the risk, in accordance with one embodiment. As an example, a customer may pay $1,200 on credit card during a purchase transaction, the merchant collects revenue of $1,200 from the transaction, and then expenses $24 in payment processing fees (e.g. 2%), which results in a net revenue of $1,176. A merchant payment processor may collect the $24 in payment processing fees on upfront payment. Then the merchant may expense $96 in transaction fees (e.g. 8%). System 100 (which may be referred to as “Butter” in the figures) may collect corresponding revenue $96 in transaction fees (e.g. 8%), then expenses $33 in transaction fees for a payment processor (e.g. 3%). System 100 may expense $1 in transaction fees for Cardlink, which may pass the $1 revenue to card network. A payment processor connected with system 100 (e.g. Stripe) may also collect revenue of $33 in payment processing fees on monthly payments. The customer's account may be debited for $1,100 upfront via Stripe payment processor. The customer may then pay $100 a month via Stripe for 11 months for the spread payment plan. Lastly, a financial institution or an entity behind system 100 may collect revenue $13 in interchange on the $1,200 upfront payment ($12) and $1,100 in monthly payments ($1).

FIG. 4B and FIG. 9 show an example flow of funds when the merchant takes the risk, in accordance with one embodiment. As an example, a customer pays $1,200 on credit card for a purchase transaction at a merchant POS, the merchant may collect revenue of $1,200 from the product or service. The merchant then may expense $24 in payment processing fees (2%) to Merchant's payment processor, and also $36 in transaction fees (3%) for payment process with system 100, which is collected by system 100. System 100 collects $1,100 from merchant for spread payment, and sends it to customer via Stripe payment processor. System 100 then may expense $33 in transaction fees for payment processor (3%) to Stripe payment processor. System 100 may also expense $1 in transaction fees for Cardlink, which may send the revenue of $1 to a card network. Once the customer receives the $1,100 for spread payment, he pays $100 a month for 11 months, which are collected by Stripe payment processor. Stripe then passes $97 a month to system 100 net of processing fee, which may be sent by system 100 to the merchant per month for the spread payment. Lastly, a financial institution or an entity behind system 100 may collect revenue $13 in interchange on the $1,200 upfront payment ($12) and $1,100 in monthly payments ($1).

FIG. 10 shows an example schematic diagram for subscription with a merchant, in accordance with one embodiment. A customer may log into system 100 and provide credit card details, and agrees to appropriate terms and conditions including terms of Cardlink. The registered credit card may be stored on file via Cardlink, or a token representing the credit card may be stored, instead of the full credit card details. Next, customer may opt-in to subscription offers in-store for a certain amount, such as $50 a month, and pays for first month in-store using the registered credit card. The merchant receives $50 in subscription, and either already having registered for system 100, or is prompted to register for system 100 and does so in real-time, then the opted-in customer and opted-in merchant are linked via Cardlink. The customer may then receive a push notification on his or her mobile device to confirm subscription. As the customer pays $50 per month for subscription, system 100 may use a payment processor (e.g. Stripe) to collect the $50 per month. Stripe may collect a processing fee, such as 3% (e.g., $1.5) of the $50. System 100 then receives $48.5 (after the processing fee) monthly, and may send part or the whole amount of $48.5 to merchant each month via appropriate payment method such as direct deposit.

FIG. 11A shows an example schematic diagram for subscription with a merchant on day 1, in accordance with one embodiment. A customer may log into system 100 and provide credit card details, and agrees to appropriate terms and conditions including terms of Cardlink. The registered credit card may be stored on file via Cardlink, or a token representing the credit card may be stored, instead of the full credit card details. System 100 may pay $1 to Cradlink. Next, customer may opt-in to subscription offers in-store for a certain amount, such as $100 a month, and pays for first month in-store using the registered credit card. Payment processor such as VISA may collect a processing fee of 2% (e.g. $2 from $100). Payment processor may pay a 1% of the subscription amount (e.g. $1 from $100) to the financial institution associated with the credit or debit card used by the customer. The merchant receives $100 in subscription, may expense $2 paid to the payment processor as processing fee, and either already having registered for system 100, or is prompted to register for system 100 and does so in real-time or near real-time, then the opted-in customer and opted-in merchant are linked via Cardlink. The customer may then receive a push notification on his or her mobile device to confirm subscription. As the customer pays $100 per month for subscription, system 100 may use a payment processor (e.g. Stripe or VISA) to collect the $100 per month. System 100 then receives $98 (after the processing fee) monthly, and may send part or the whole amount of $98 to the merchant each month via appropriate payment method such as direct deposit.

FIG. 11B shows an example schematic diagram for subscription with a merchant post day 30, in accordance with one embodiment. A customer may, at this point, pay $100 per month for a subscription. A payment processor such as Stripe may collect a processing fee, such as 3% (e.g., $3) of the $100. The payment processor may send an appropriate amount such as 1% of the monthly payment (e.g. $1 from $100) to the financial institution associated with the credit or debit card used by the customer. System 100 may then receive $97 (after the processing fee) monthly from the payment processor net of processing fee, recognize a 10% revenue of $10 and expense 3% fee (e.g. $3), and may send part or the whole amount of $90 to merchant each month via appropriate payment method such as direct deposit. The merchant may recognize a revenue of $100 per month and expense a 10% processing fee (e.g. $10).

FIG. 5A shows an example process 500 for merchant registration via system 100, in accordance with one embodiment. At step 501, via a merchant web interface provided by system 100, a merchant signs up with system 100 to spread payments, providing Merchant IDs, offer details, payment info (e.g. electronic funds transfer), and/or receives terms and conditions to which merchant needs to agree. At step 502, Merchant IDs and offers are registered with card network via Cardlink API with permission so one or more sets of transaction data can be passed back to system 100.

In some embodiments, the transaction data may include credit card digits, credit card owner, merchant name, merchant ID, merchant location, merchant contact details, merchant category, transaction ID, SKU, transaction amount, transaction currency, a bank identification number (BIN) and an Authorization Code.

At step 503, the merchant through the merchant web interface by system 100 may receive confirmation that the merchant ID and offers are registered with system 100. A merchant 540 may register different offer programs, each program may include details such as cards, web hooks, brands, locations, transactions, and so on.

FIG. 5B shows an example consumer pre-registration process 510 via system 100, in accordance with one embodiment. At step 504, a financial institution may issue credit card to a customer. At step 505, customer may create an account with name, email and password on system 100 (also referred to as “Butter”). At step 506, using a customer application by system 100, the customer may pre-register credit card by providing card details and agreeing to T&Cs. At step 507, system 100 may send card details to Cardlink API or iFrame for transmission to the card network (e.g. Visa, MasterCard or Amex). At step 508, a payment processor (e.g. Stripe) may be used by system 100 to perform a pre-authorization to validate the registered card on system 100 via API. At step 509, system 100 may receive a hashed version (e.g. tokenization) of the credit card number from card network. At step 511, system 100 may receive a hashed version (e.g. tokenization) of the credit card number from a payment processor. The hashed version or tokenization of the credit card is then stored in a database of system 100 at step 512.

In some embodiments, an electronic transaction can involve data processing tasks. A first task can be to authorize a charge, and a 2^{nd} task can be to settle the charge. When he charges authorize, the resources can be reserved or otherwise guaranteed in the purchaser resource pool. In some embodiments, the quantity of the resource associated with the authorized to charge can be held for a defined period for example 7 days. If the charge is not captured or otherwise settled within this defined. The authorization can be canceled and the resources can be released.

FIG. 5C shows an example consumer transaction process 520, in accordance with one embodiment. At step 513, a Merchant POS may scan/enter the product into the POS Card presented by customer for payment. In some embodiments, the purchase amount must be of a minimum amount before it can be eligible for a spreading payment plan. The minimum amount may be set by the merchant or by system 100.

At step 514, Merchant Payment Processor may swipe and validate the credit card, receiving confirmation that the credit card has available credit for purchase. At step 515, using Cardlink, the transaction data (e.g. amount, time stamp, MID, etc.) may be passed back to system 100. In some embodiments, transaction data may include one or more of the following information.

```
″CardId″: ″6f1fd4a3-53bb-e711-80ee-1c98ec1324d5″,
″Key″: ″User.EUID″,
  ″Value″: ″MONTREALTEST01″
″Key″: ″Card.Bin″,
  ″Value″: ″451401″
″Key″: ″User.PanLastFour″,
  ″Value″: ″7517″
″Key″: ″Transaction.PanLastFour″,
  ″Value″: ″7517″
″Key″: ″Transaction.MerchantCardAcceptorId″,
  ″Value″: ″0030108124224″
″Key″: ″Transaction.MerchantAcquirerBin″,
  ″Value″: ″406449″
″Key″: ″Transaction.MerchantName″,
  ″Value″: ″BISTRO GURU″
″Key″: ″Transaction.MerchantCity″,
  ″Value″: ″MONTREAL″
″Key″: ″Transaction.MerchantState″,
  ″Value″: ″QC″
″Key″: ″Transaction.MerchantPostalCode″,
  ″Value″: ″″
″Key″: ″Transaction.TransactionAmount″,
  ″Value″: ″40″
″Key″: ″Transaction.VipTransactionId″,
  ″Value″: ″307303733596162″
″Key″: ″Transaction.VisaMerchantName″,
  ″Value″: ″BISTRO GURU″
″Key″: ″Transaction.VisaMerchantId″,
  ″Value″: ″13327079″
″Key″: ″Transaction.VisaStoreName″,
  ″Value″: ″BISTRO GURU″
″Key″: ″Transaction.VisaStoreId″,
  ″Value″: ″167799970″
″Key″: ″Transaction.MerchantCategoryCode″,
  ″Value″: ″5812″
″Key″: ″Transaction.MerchantCountryCode″,
  ″Value″: ″124″
″Key″: ″Transaction.BillingCurrencyCode″,
  ″Value″: ″124″
″Key″: ″Transaction.USDAmount″,
  ″Value″: ″31.24″
″Key″: ″Transaction.TimeStampYYMMDD″,
  ″Value″: ″2017-10-30T21:22:39″
″Key″: ″Transaction.BillingAmount″,
  ″Value″: ″40″
″Key″: ″Offer.ActiveationId″,
  ″Value″: ″5d9910ff-e85c-4aaa-82fb-276adfad56df″
″Key″: ″Offer.OfferId″,
  ″Value″: ″69312″
```

At step 516, a Merchant Bank Account may receive a full purchase amount deposited into merchant bank account minus certain payment processor fees. At step 517, a push notification may be sent to a registered customer based on transaction data such as matching MID, transaction amount, and/or transaction timestamp. Once the customer has confirmed to proceed with the spread payment plan, at step 518, a card network or Cardlink API of system 100 may request Cardlink to process a refund of the purchase amount immediately, in real time or near real time. The amount of the refund may be determined based on the exact spread payment plan. For example, if the payment plan is to pay the entire amount over 12 months, then 11/12^{th} of the overall transaction amount paid by the customer may be refunded back to the customer.

For another example, the payment plan may be spreading the full purchase amount over 10 payments, in which case each payment may be 1/10^{th} of the full purchase amount. In some embodiments, each payment may not be equal, for instance, if the full purchase amount is $1,000, a first payment may be $300, a second payment may be $200, and there may be five subsequent payments, each of $100.

A refund may indicate a payment to the customer's bank account or credit card account, without the customer having to return the purchased item or merchandise. In this case, a refund may indicate a credit back to the customer.

At step 519, system 100 may make an API call to process a pre-authorization on the credit card of an amount equal to the refunded amount (e.g. 11/12ths of the purchase amount) at the same time. At step 521, system 100 may generate a push notification to customer to confirm that spread payment plan was successful. At step 522, system 100 may process contact Merchant Bank Account for the appropriate transaction fee for providing the spread payment plan.

FIG. 5D shows an example consumer payment plan process 530, in accordance with one embodiment. At step 531, on a monthly basis, if the spread payment plan is to pay back the entire amount in 12 months, a payment processor of system 100 (e.g. Stripe payment processor) may process 1/12^{th} payment against the pre-authorized credit card each month. At step 532, payment processor of system 100 may reduce the pre-authorization amount by the same 1/12^{th} amount. This step is repeated until the entire spread amount is fully paid. At step 533, monthly payments received by system 100 may be kept with a financial institution (if system 100 took the risk) or remitted back to the merchant (if merchant took the risk), minus appropriate payment processing fees.

In some embodiments, pre-authentication and re-authentication processes may occur a few times per month, for example, pre-authentication and/or re-authentication process may occur every 3-5 days. Each time an pre-authentication is required, the pre-authentication amount may be reduced by an amount that has been paid in the previous payment installment.

In some embodiments, payments after the initial transaction for the first payment may use a different payment method than the credit card that has been used in the initial transaction for the first payment. For example, the customer may sign a loan agreement with a financial institution that has pre-registered with system 100, or the customer may pay monthly through a HELOC, through an actual installment loan, through a PayPal monthly billing agreement, and so on. This may apply to either or both of subscription and spread payment plans.

In some embodiments, the subsequent payment installments may not start until after a certain period of time, for example, the payment installments may not start until after 5 months. In some embodiments, the payment may be delayed for a period of time, then may be paid in full in one transaction. This may apply to either or both of subscription and spread payment plans.

FIG. 6 shows an example consumer transaction process 710 for a subscription payment plan, according to some embodiments. At step 721, a Merchant POS may scan/enter the product into the POS Card presented by customer for payment. In some embodiments, the price point for the proposed transaction needs to match an offer provided and registered by the merchant.

At step 722, Merchant Payment Processor may swipe and validate the credit card, receiving confirmation that the credit card has available credit for purchase. At step 724, using Cardlink, the transaction data (e.g. amount, time stamp, MID, etc.) may be passed back to system 100. In some embodiments, transaction data may include one or more of the following information.

```
″CardId″: ″6f1fd4a3-53bb-e711-80ee-1c98ec1324d5″,
″Key″: ″User.EUID″,
  ″Value″: ″MONTREALTEST01″
″Key″: ″Card.Bin″,
  ″Value″: ″451401″
″Key″: ″User.PanLastFour″,
  ″Value″: ″7517″
″Key″: ″Transaction.PanLastFour″,
  ″Value″: ″7517″
″Key″: ″Transaction.MerchantCardAcceptorId″,
  ″Value″: ″0030108124224″
″Key″: ″Transaction.MerchantAcquirerBin″,
  ″Value″: ″406449″
″Key″: ″Transaction.MerchantName″,
  ″Value″: ″BISTRO GURU″
″Key″: ″Transaction.MerchantCity″,
  ″Value″: ″MONTREAL″
″Key″: ″Transaction.MerchantState″,
  ″Value″: ″QC″
″Key″: ″Transaction.MerchantPostalCode″,
  ″Value″: ″″
″Key″: ″Transaction.TransactionAmount″,
  ″Value″: ″40″
″Key″: ″Transaction.VipTransactionId″,
  ″Value″: ″307303733596162″
″Key″: ″Transaction.VisaMerchantName″,
  ″Value″: ″BISTRO GURU″
″Key″: ″Transaction.VisaMerchantId″,
  ″Value″: ″13327079″
″Key″: ″Transaction.VisaStoreName″,
  ″Value″: ″BISTRO GURU″
″Key″: ″Transaction.VisaStoreId″,
  ″Value″: ″167799970″
″Key″: ″Transaction.MerchantCategoryCode″,
  ″Value″: ″5812″
″Key″: ″Transaction.MerchantCountryCode″,
  ″Value″: ″124″
″Key″: ″Transaction.BillingCurrencyCode″,
  ″Value″: ″124″
″Key″: ″Transaction.USDAmount″,
  ″Value″: ″31.24″
″Key″: ″Transaction.TimeStampYYMMDD″,
  ″Value″: ″2017-10-30T21:22:39″
″Key″: ″Transaction.BillingAmount″,
  ″Value″: ″40″
″Key″: ″Offer.ActiveationId″,
  ″Value″: ″5d9910ff-e85c-4aaa-82fb-276adfad56df″
″Key″: ″Offer.OfferId″,
  ″Value″: ″69312″
```

At step 723, a Merchant Bank Account may receive a full purchase amount deposited into merchant bank account minus certain payment processor fees. At step 725, a push notification may be sent to a registered customer based on transaction data such as matching MID, transaction amount, and/or transaction timestamp. Once the customer has confirmed to proceed with the subscription payment plan, at step 726, a confirmation of successful subscription plan may be displayed to the customer.

FIG. 7 shows an example consumer payment process 720 for a subscription payment plan, in accordance with one embodiment. At step 731, on a monthly basis, system 100 may process the subscription amount against the pre-authorized credit card using a payment processor such as Stripe. At step 732, payment processor of system 100 may receive a monthly payment less processing fees. At step 733, monthly payments received by system 100 may be kept with a financial institution (if system 100 took the risk) or remitted back to the merchant (if merchant took the risk), minus appropriate payment processing fees.

FIGS. 12A to 12D show example mobile device interfaces for a consumer, in accordance with one embodiment.

FIG. 12C is a set of three interface screenshots illustrative of execution of the data processing task. As shown in FIG. 12C, an interface screen is rendered in relation to steps of a transaction involving the data processing task. In this example, offers are shown to be rendered in visual interface elements of the graphic user interface (in this example, a screen or a display of a mobile device). The interface screen includes an offer, for example, to individuals having a specific credential (e.g., Nexus passholders). This offer could be related to the option for deferred execution having improved financial characteristics (e.g., $50 bonus), and verification may be required. Additional interface screens are provided showing a credential verification/upload page, and a help screen for providing assistance through a chat interface.

FIG. 12D is a set of two screen renderings adapted for redeeming bonus points or other virtual currency or tokens, as well as a page for a user to provide personal details, for example, through input text fields.

FIG. 14 is a set of three interface screens showing a sample flow for providing redemption and point accumulation information to a user, rendered on various visual elements. An intake process is shown whereby a user connects an account to a financial institution account, and preferential return rates may be obtained, for example, by applying for a corresponding financial product (e.g., credit card).

FIG. 15 is a set of three interface screen renderings showing an extracted list of subscription payments that are extracted, for example, automatically from a a set of data records representative of financial transaction details for a user. In this example, subscription (e.g., monthly payments) are shown in the middle screen rendering. On the screen rendering on the right, a single payment is converted into a set of installment payments. The conversion process can be, in some embodiments, be merchant/payment service agonistic, and instead be handled on as a backend data process that spawns deferred child data processing tasks upon receiving an input instruction from the user to pay in installments (e.g., to defer execution of a full data process). For example, for a purchase of a large expense item (e.g., a laptop), the system can be adapted to intercept the payment process in a manner that is not visible to the merchant. The merchant can receive payment in full from the system, while the system may generate a series of spawned child processes, each spawned child process corresponding to an installment payment for part of the cost of the large expense item, such that the spawned child processes are executed at future times.

FIG. 16 is an interface screen rendering directed to a help/chatbot screen to provide assistance if necessary. FIG. 17 is an interface screen showing a similar rendering to that of FIG. 14 in relation to onboarding a user by coupling to one or more financial institution accounts. In this example, the deferred child data processing tasks may be linked to the coupled accounts such that payments are provided from or to the coupled accounts upon execution of the deferred child data processing tasks.

FIG. 18 is an interface screen rendering directed to detection of subscription payments as automatically extracted from the data set of financial transactions. FIG. 19 is an interface screen rendering directed to account coupling and onboarding. FIG. 20 is another interface screen rendering directed to detection of subscription payments as automatically extracted from the data set of financial transactions.

FIG. 21 is an interface screen rendering showing a set of visual elements corresponding to subscription payments that have been extracted from the data set of financial transactions. In this example, cashback amounts, transaction accounts, payment dates, and other data, such as categories, have been extracted and appended to the visual elements. A similar interface screen rendering is shown in FIG. 22, except that the system detects that some of the payments are made on a specific financial instrument (e.g., linked credit card), and that payment is shown separately on a separate visual interface element area or widget.

FIG. 23 is an interface screen rendering showing a potential integration with an enterprise online banking system whereby the signals including instructions to defer execution and opportunities thereof to convert payments to be spread as installment payments is provided as a visual interface controllable element. In particular, specific transactions listed on the online banking, upon receiving an input from a user (e.g., through a touch screen selection or a mouse pointer selection) initiates the instructions to defer execution. A data process is invoked in which the set of one or more deferred child data processing tasks are spawned or generated from an originating data processing task and resources may be consumed from a resource pool (e.g., existing funds in the account) over time. In this example, a line of credit account may be utilized to provide revolving credit that can be used to support or offset time value of money discount factors associated with the deferral by linking the one or more deferred child data processing tasks with appended interest payments associated with the line of credit account.

FIG. 24 is an interface screen rendering showing an confirmation to the user. FIG. 25 is an interface screen showing upcoming child data processing tasks in an online-banking user interface. FIG. 26 is an interface screen showing an explanation of the transaction installment process.

In some embodiments, the processor can be configured to generate child data processing tasks for electronic transactions for reward points based on received transaction data sets. FIG. 27 is a user interface showing available rewards offers which correspond to one or more offer data sets defining trigger conditions which when satisfied will trigger the generate of child data processing tasks to executed the electronic transactions to reward points.

FIG. 28 shows examples user interfaces which in some embodiments, may be generated in conjunction with the method of FIG. 2D.

FIG. 29 shows examples user interfaces which in some embodiments, may be generated in conjunction with the method of FIG. 2C.

FIG. 13 is a schematic block diagram of an example computing device 600 implementing system 100, according to some embodiments. As depicted, computing device 600 includes at least one processor 602, memory 604, at least one I/O interface 606, and at least one network interface 608. The computing device 600 may be configured as a machine learning server adapted to dynamically maintain one or more neural networks.

Each processor 602 may be a microprocessor or microcontroller, a digital signal processing (DSP) processor, an integrated circuit, a field programmable gate array (FPGA), a reconfigurable processor, a programmable read-only memory (PROM), or combinations thereof.

Memory 604 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

Each I/O interface 606 enables computing device 600 to interconnect with one or more input devices, such as a keyboard, mouse, camera, touch screen and a microphone, or with one or more output devices such as a display screen and a speaker.

A networking interface 608 may be configured to receive and transmit data sets representative of the machine learning models, for example, to a target data storage or data structures. The target data storage or data structure may, in some embodiments, reside on a computing device or system such as a mobile device.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

What is claimed is:

1. A method for executing a data processing task for an electronic transaction, the method comprising:
receiving an electronic transaction data set including parameters associated with a first data processing task for executing the electronic transaction, the parameters identifying a quantity of an electronic resource consumed from a purchaser resource pool by the data processing task;
generating signals for communicating an electronic message to a destination associated with the purchaser resource pool, the electronic message communicating an option for deferring execution of at least a portion of the data processing task thereby deferring a corresponding consumption of at least a portion of the quantity of the electronic resource from the purchaser resource pool;
upon receiving response signals indicative of instructions to defer execution, generating a second data processing task for releasing at least the portion of the electronic resource to the purchaser resource pool; and
generating one or more deferred child data processing tasks for executing at least the portion of the data processing task at one or more future times; when executed, the one or more deferred child data processing tasks consuming at least the portion of the quantity of the electronic resource from the purchaser resource pool.

2. The method of claim 1, where the electronic transaction data set is received from a transaction processing system configured to execute data processing tasks for consuming or adding electronic resources to one or more resource pools.

3. The method of claim 1, wherein the parameters associated with the data processing task include a payment token, the method comprising:
identifying, from a plurality of user data profiles stored at a data storage device, a first user data profile associated with the payment token; determining the destination to which the electronic message is to be communicated based on a destination associated with the first user data profile.

4. The method of claim 1, comprising:
receiving a data set for a new user data profile, the new data set including a payment identifier;
sending a registration message including the payment identifier to a transaction processing system, wherein registration of the payment identifier enables the transaction processing system to send an electronic transaction data set for each data processing task associated with the payment identifier, the electronic transaction data set including a payment token;
receiving, from the transaction processing system, a response message including the payment token;
storing the payment token in associated with the new user data profile and
deleting the payment identifier.

5. The method of claim 1, comprising: generating one or more data processing tasks for reserving one or more portions of the quantity of the electronic resource in the purchaser resource pool; wherein when executed, the one or more deferred child data processing tasks consuming the one or more reserved portions of the quantity of the electronic resource.

6. The method of claim 1, wherein the signals for communicating the electronic message communicating the option for deferring execution of at least a portion of the data processing task are generated when one or more of the parameters satisfy a deferral condition.

7. The method of claim 6, wherein the deferral condition is satisfied:
when the quantity of the electronic resource consumed from a purchaser resource pool meets a threshold value;
when an identifier associated with a merchant involved in the electronic transaction matches one or more triggering merchant identifiers; or
when a merchant category code associated with the merchant involved in the electronic transaction matches one or more triggering merchant category codes.

8. The method of claim 1, comprising: generating signals for triggering display of a user interface at a device associated with the purchaser resource pool, the user interface enabling selection of one or more options for deferring execution of at least the portion of the data processing task.

9. The method of claim 1, wherein the one or more options include options defining at least one of: a number of deferred child data processing tasks to be generated; a deferred quantity of the electronic resource to be consumed by the one or more deferred child data processing tasks; or the one or more future times at which the one or more deferred child data processing tasks are to be executed.

10. The method of claim 1, comprising:
upon determining from the parameters associated with the first data processing task for executing the electronic transaction satisfy a subscription condition, generating signals for communicating a subscription electronic message to the destination associated with the purchaser resource pool, the subscription electronic message communicating an option for triggering execution of a plurality of future data processing tasks for periodically consuming subscription quantities of the electronic resource from the purchaser resource pool;
upon receiving subscription response signals indicative of a confirmation the option for triggering execution of a plurality of future data processing tasks for periodically consuming the subscription quantities, generating signals for initiating execution of the plurality of future child data processing tasks at one or more future subscription times.

11. A system for managing resource consumption for electronic transaction data processes, the system comprising at least one processor configured for:
receiving an electronic transaction data set including parameters associated with a first data processing task for executing the electronic transaction, the parameters identifying a quantity of an electronic resource consumed from a purchaser resource pool by the data processing task;
generating signals for communicating an electronic message to a destination associated with the purchaser resource pool, the electronic message communicating an option for deferring execution of at least a portion of the data processing task thereby deferring a corresponding consumption of at least a portion of the quantity of the electronic resource from the purchaser resource pool;
upon receiving response signals indicative of instructions to defer execution, generating a second data processing task for releasing at least the portion of the electronic resource to the purchaser resource pool; and
generating one or more deferred child data processing tasks for executing at least the portion of the data processing task at one or more future times; when executed, the one or more deferred child data processing tasks consuming at least the portion of the quantity of the electronic resource from the purchaser resource pool.

12. The system of claim 11, where the electronic transaction data set is received from a transaction processing system configured to execute data processing tasks for consuming or adding electronic resources to one or more resource pools.

13. The system of claim 11, wherein the parameters associated with the data processing task include a payment token, and the at least one processor is configured for:
identifying, from a plurality of user data profiles stored at a data storage device, a first user data profile associated with the payment token; determining the destination to which the electronic message is to be communicated based on a destination associated with the first user data profile.

14. The system of claim 11, wherein the at least one processor configured for:
receiving a data set for a new user data profile, the new data set including a payment identifier;
sending a registration message including the payment identifier to a transaction processing system, wherein registration of the payment identifier enables the transaction processing system to send an electronic transaction data set for each data processing task associated with the payment identifier, the electronic transaction data set including a payment token;
receiving, from the transaction processing system, a response message including the payment token;
storing the payment token in associated with the new user data profile and
deleting the payment identifier.

15. The system of claim 11, wherein the at least one processor configured for: generating one or more data processing tasks for reserving one or more portions of the quantity of the electronic resource in the purchaser resource pool; wherein when executed, the one or more deferred child data processing tasks consuming the one or more reserved portions of the quantity of the electronic resource.

16. The system of claim 11, wherein the signals for communicating the electronic message communicating the option for deferring execution of at least a portion of the data processing task are generated when one or more of the parameters satisfy a deferral condition.

17. The system of claim 16, wherein the deferral condition is satisfied:
when the quantity of the electronic resource consumed from a purchaser resource pool meets a threshold value;
when an identifier associated with a merchant involved in the electronic transaction matches one or more triggering merchant identifiers; or
when a merchant category code associated with the merchant involved in the electronic transaction matches one or more triggering merchant category codes.

18. The system of claim 11, wherein the at least one processor configured for: generating signals for triggering display of a user interface at a device associated with the purchaser resource pool, the user interface enabling selection of one or more options for deferring execution of at least the portion of the data processing task.

19. The system of claim 11, wherein the at least one processor configured for:
upon determining from the parameters associated with the first data processing task for executing the electronic transaction satisfy a subscription condition, generating signals for communicating a subscription electronic message to the destination associated with the purchaser resource pool, the subscription electronic message communicating an option for triggering execution of a plurality of future data processing tasks for periodically consuming subscription quantities of the electronic resource from the purchaser resource pool;
upon receiving subscription response signals indicative of a confirmation the option for triggering execution of a plurality of future data processing tasks for periodically consuming the subscription quantities, generating signals for initiating execution of the plurality of future child data processing tasks at one or more future subscription times.

20. A non-transitory computer readable medium or media having stored thereon computer readable instructions which when executed by at least one processor, configure the at least one processor for:
receiving an electronic transaction data set including parameters associated with a first data processing task for executing the electronic transaction, the parameters identifying a quantity of an electronic resource consumed from a purchaser resource pool by the data processing task;
generating signals for communicating an electronic message to a destination associated with the purchaser resource pool, the electronic message communicating an option for deferring execution of at least a portion of the data processing task thereby deferring a corresponding consumption of at least a portion of the quantity of the electronic resource from the purchaser resource pool;
upon receiving response signals indicative of instructions to defer execution, generating a second data processing task for releasing at least the portion of the electronic resource to the purchaser resource pool; and
generating one or more deferred child data processing tasks for executing at least the portion of the data processing task at one or more future times; when executed, the one or more deferred child data processing tasks consuming at least the portion of the quantity of the electronic resource from the purchaser resource pool.
